(19) United States
(12) Patent Application Publication
(10) Pub. No.: US 2010/0293090 A1
(43) Pub. Date: Nov. 18, 2010

(54) SYSTEMS, METHODS, AND APPARATUS FOR DETERMINING FRAUD PROBABILITY SCORES AND IDENTITY HEALTH SCORES

(76) Inventors: Steven D. Domenikos, Millis, MA (US); Stamatis Astras, Boston, MA (US); Iris Seri, Roslindale, MA (US); Steven E. Samler, Andover, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/780,130

(22) Filed: May 14, 2010

Related U.S. Application Data
(60) Provisional application No. 61/178,314, filed on May 14, 2009.
(60) Provisional application No. 61/225,401, filed on Jul. 14, 2009.

(51) Int. Cl. G06N 5/02; G06Q 99/00; G06Q 40/00

(52) U.S. Cl. 705/38; 705/325; 706/52

(57) ABSTRACT

In general, in one embodiment, a computing system that evaluates a fraud probability score for an identity event relevant to a user first queries a data store to identify the identity event. A fraud probability score is then computed for the identity event using a behavioral module that models multiple categories of suspected fraud.

### CROSS-REFERENCE TO RELATED APPLICATIONS

This application claims priority to and the benefit of, and incorporates herein by reference in their entireties, U.S. Provisional Patent Application No. 61/178,314, which was filed on May 14, 2009, and U.S. Provisional Patent Application No. 61/225,401, which was filed on Jul. 14, 2009.

### TECHNICAL FIELD

Embodiments of the current invention generally relate to systems, methods, and apparatus for protecting people from identity theft. More particularly, embodiments of the invention relate to systems, methods, and apparatus for analyzing potentially fraudulent events to determine a likelihood of fraud and for communicating the results of the determination to a user.

### BACKGROUND

In today's society, people generally do not know where their private and privileged information is being used, by whom, and for what purpose. This gap in “identity awareness” may give rise to identity theft, which is growing at epidemic proportions. Once an identity thief has obtained personal data, identity fraud can happen quickly; typically, much faster than the time it takes to finally appear on a credit report. The concept of identity is not restricted to only persons, but applies also to devices, applications, and physical assets that comprise additional identities to manage and protect in an increasingly networked, interconnected, and always-on world.

Traditional consumer-fraud protection solutions are based on monitoring and reporting only on credit and banking-based activities. These solutions typically offer services such as credit monitoring (i.e., monitoring activity on a consumer's credit card), fraud alerts (i.e., warning messages placed on a credit report), credit freezes (i.e., locking down credit files so they may not be released without the consumer's permission) and/or financial account alerts (i.e., warning of suspicious activity on a on-line checking or credit account). These services, however, may monitor only a small portion of the types of identity theft a consumer may risk. Other types of identity theft (e.g., utilities fraud, bank fraud, employment fraud, loan fraud, and/or government fraud) account for the bulk of reported incidents. At most, prior-art monitoring systems analyze only a user's history to attempt to determine if a current identity event is at odds with that history; these systems, however, may not accurately categorize the identity event, especially when the user's history is inaccurate or unreliable. Furthermore, traditional consumer-fraud protection services notify a consumer only after an identity theft has taken place.

Therefore, a need exists for a proactive identity protection service that identifies identity risks prior to reputation, credit, and financial harms through the use of continuous monitoring, sophisticated modeling of fraud types, and timely communication of suspicious events.

### SUMMARY OF THE INVENTION

Embodiments of the present invention address the limitations of prior-art, reactive reporting by using predictive modeling to identify actual, potential, and suspicious identity fraud events as they are discovered. A modeling platform gathers, correlates, analyzes, and predicts actual or potential fraud outcomes using different fraud models for different types of events. Data normally ignored by prior art monitoring services, such as credit-header data, is gathered and analyzed even if it doesn't match the identity of the person being monitored. Multiple public and private data sources, in addition to the credit application system used in prior-art monitors, may be used to generate a complete view of a user. Patterns of behavior may be analyzed for increasingly suspicious identity events that may be a preliminary indication of identity fraud. The results of each event may be communicated to a consumer as a fraud probability score summarizing the risk of each event, and an overall identity health score may be used as an aggregate measure of the consumer's current identity risk level based on the influence that each fraud probability score has on the consumer's identity. The solutions described herein address, in various embodiments, the problem of proactively identifying identity fraud.

In general, in one aspect, embodiments of the invention feature a computing system that evaluates a fraud probability score for an identity event. The computing system includes search, behavioral, and fraud probability modules. The search module queries a data store to identify an identity event relevant to a user. The data store stores identity event data and the behavioral module models a plurality of categories of suspected fraud. The fraud probability module computes, and stores in computer memory, a fraud probability score indicative of a probability that the identity event is fraudulent based at least in part on applying the identity event to a selected one of the categories modeled by the behavioral module.

The identity event may include a name identity event, an address identity event, a phone identity event, and/or a social security number identity event. The identity event may be a non-financial event and/or include credit header data. Each modeled category of suspected fraud may be based at least in part on demographic data and/or fraud pattern data. An identity health score module may compute an identity health score for the user based at least in part on the computed fraud probability score. A history module may compare the identity event to historical identity events linked to the identity event, and the fraud probability score may further depend on a result of the comparison. A fraud severity module may assign a severity to the identity event, and the identity health score may further depend on the assigned severity. The fraud probability module may aggregate a plurality of computed fraud probability scores and may compute the fraud probability score dynamically as the identified identity event occurs.

The fraud probability module may include a name fraud probability module, an address fraud probability module, a social security number fraud probability module, and/or a phone number fraud probability module. The name fraud probability module may compare a name of the user to a name associated with the identified identity event and may compute the fraud probability score using at least one of a longest-common-substring algorithm or a string-edit-distance algorithm. The name fraud probability module may generate groups of similar names, a first group of which includes the name of the user, and may compare the name associated with the identified identity event to each group of names. The social security number fraud probability module may compare a social security number of the user to a social security number associated with the identified identity event. The address fraud probability module may compare an address of the user to an address associated with the identified identity event. The phone number fraud probability module may compare a phone number of the user to a phone number associated with the identified identity event.

In general, in another aspect, embodiments of the invention feature an article of manufacture storing computer-readable instructions thereon for evaluating a fraud probability score for an identity event relevant to a user. The article of manufacture includes instructions that query a data store storing identity event data to identify an identity event relevant to an account of the user. The identity event has information that matches at least part of one field of information in the account of the user. Further instructions compute, and thereafter store in computer memory, a fraud probability score indicative of a probability that the identity event is fraudulent by applying the identity event to a model selected from one of a plurality of categories of suspected fraud models modeled by a behavioral module. Other instructions cause the presentation of the fraud probability score on a screen of an electronic device.

The fraud probability score may include a name fraud probability score, a social security number fraud probability score, an address fraud probability score, and/or a phone fraud probability score. The instructions that compute may include instructions that use a longest-common-substring algorithm and/or a string-edit-distance algorithm and may include instructions that group similar names (a first group of which includes the name of the user) and/or compare a name associated with the identity event to each group of names.

In general, in yet another aspect, embodiments of the invention feature a method for evaluating a fraud probability score for an identity event relevant to a user. The method begins by querying a data store storing identity event data to identify an identity event relevant to an account of the user. The identity event has information that matches at least part of one field of information in the account of the user. A fraud probability score indicative of a probability that the identity event is fraudulent is computed (and thereafter stored in computer memory) by applying the identity event to a model selected from one of a plurality of categories of suspected fraud models modeled by a behavioral module. The fraud probability score is presented on a screen of an electronic device.

The step of computing the fraud probability score may further include using historical identity data to compare the identity event to historical identity events linked to the identity event. The fraud probability score may further depend on a result of the comparison. A severity may be assigned to the identity event, and the fraud probability score may further depend on the assigned severity. An identity health score may be computed based at least in part on the computed fraud probability score.

In general, in still another aspect, embodiments of the invention feature a computing system that provides an identity theft risk report to a user. The computing system includes fraud probability, identity health, and reporting modules, and computer memory. The fraud probability module computes, and thereafter stores in the computer memory, at least one fraud probability score for the user by comparing the identity event data with the identity information provided by the user. The identity health module computes, and thereafter stores in the computer memory, an identity health score for the user by evaluating the user against the statistical financial and demographic information. The reporting module provides an identity theft risk report to the user that includes at least the fraud probability and identity health scores of the user. The computer memory stores identity event data, identity information provided by a user, and statistical financial and demographic information.

The reporting module may communicate a snapshot report to a transaction-based user and/or a periodic report to a subscription-based user. The user may be a private person, and the reporting module may communicate the identity theft risk report to a business and/or a corporation.

In general, in still another aspect, embodiments of the invention feature an article of manufacture storing computer-readable instructions thereon for providing an identity theft risk report to a user. The article of manufacture includes instructions that compute, and thereafter store in computer memory, at least one fraud probability score for the user by comparing identity event data stored in the computer memory with identity information provided by the user. Further instructions compute, and thereafter store in the computer memory, an identity health score for the user by evaluating the user against statistical financial and demographic information stored in the computer memory. Other instructions provide an identity theft risk report to the user that includes at least the fraud probability and identity health scores of the user.

In general, in still another aspect, embodiments of the invention feature a computing system that provides an online identity health assessment to a user. The system includes user input, calculation, and display modules, and computer memory. The user input module accepts user input designating an individual other than the user (having been presented to the user on an internet web site) for an online identity health assessment. The calculation module calculates an online identity health score for the other individual using information identifying, at least in part, the other individual. The display module causes the calculated online identity health score of the other individual to be displayed to the user. The computer memory stores the calculated online identity health score for the other individual.

The internet website may be a social networking web site, a dating web site, a transaction web site, and/or an auction web site. The information identifying the other individual may be unknown to the user.

In general, in still another aspect, embodiments of the invention feature an article of manufacture storing computer-readable instructions thereon for providing an online identity health assessment to a user. The article of manufacture includes instructions that accept user input designating an individual other than the user (having been presented to the user on an internet web site) for an online identity health assessment. Further instructions calculate, and thereafter store in computer memory, an online identity health score for the other individual using information identifying, at least in part, the other individual. Other instructions cause the calculated online identity health score for the other individual to be displayed to the user.

### BRIEF DESCRIPTION OF THE DRAWINGS

The foregoing and other objects, aspects, features, and advantages of the invention will become more apparent and may be better understood by referring to the following description, taken in conjunction with the accompanying drawings, in which:

FIG. 1 is a diagram of an identity event analysis system in accordance with an embodiment of the invention;

FIG. 2 is a block diagram of a fraud probability score computation system in accordance with an embodiment of the invention;

FIG. 3 is a flowchart illustrating a method for computing a fraud probability score in accordance with an embodiment of the invention;

FIGS. 4 and 5 are two-dimensional graphs of fraud probability scores represented as vectors in accordance with embodiments of the invention;

FIG. 6 is a screenshot of an identity theft risk report in accordance with an embodiment of the invention;

FIG. 7 is a screenshot of an identity overview subsection within an identity theft risk report in accordance with an embodiment of the invention;

FIG. 8 is a screenshot of a fraud report subsection within an identity theft risk report in accordance with an embodiment of the invention;

FIG. 9 is a screenshot of a detected breach report subsection within an identity theft risk report in accordance with an embodiment of the invention;

FIG. 10 is a screenshot of a health score detail report subsection within an identity theft risk report in accordance with an embodiment of the invention;

FIG. 11 is a screenshot of a wallet protect report subsection within an identity theft risk report in accordance with an embodiment of the invention;

FIG. 12 is a screenshot of an online truth application in accordance with an embodiment of the invention;

FIG. 13 is a screenshot of a web site running an online truth application in accordance with an embodiment of the invention;

FIG. 14 is a screenshot of a user input field for inputting data for an online truth application in accordance with an embodiment of the invention;

FIG. 15 is a screenshot of a publishing option for a completed online truth application in accordance with an embodiment of the invention; and

FIG. 16 is a block diagram of a system for providing an online identity health assessment for a user in accordance with an embodiment of the invention.

### DETAILED DESCRIPTION

Described herein are various embodiments of methods, systems, and apparatus for detecting identity theft. In one embodiment, a fraud probability score is calculated on an event-by-event basis for each potentially fraudulent event associated with a user's account. The user may be a person, a group of people, a business, a corporation, and/or any other entity. An event's fraud probability score may change over time as related events are discovered along a fraud outcome timeline. One or more fraud probability scores, in addition to other data, may be combined into an identity health score, which is an overall risk measure that indicates the likelihood that a user is a victim (or possible victim) of identity-related fraud and the anticipated severity of the possible fraud. In another embodiment, an identity risk report is generated on a one-time or subscription basis to show a user's overall identity health score. In yet another embodiment, an online health algorithm is employed to determine the identity health of third parties met on the Internet. In each embodiment, a user may receive the identity theft information as part of a paid subscription service (i.e., as part of an ongoing identity monitoring process) or as a one-off transaction. The user may interact with the paid subscription service, or receive the one-off transaction, via a computing device over the world-wide-web. Each embodiment described herein may be used alone, in combination with other embodiments, or in combination with embodiments of the invention described in U.S. Patent Application Publication No. 2008/0103798 (hereinafter, “the '798 publication”), which is hereby incorporated herein by reference in its entirety.

In general, the likelihood that a user is a victim of identity fraud is based on an analysis of one or more identity events, which are all financial, employment, government, or other events relevant to a user's identity health, such as, for example, a credit card transaction made under the user's name but without the user's knowledge. Information within an identity event may be related to a user's name (i.e., a name or alias identity event), related to a user's address (i.e., an address identity event), related to a user's phone number (i.e., a phone number identity event), or related to a user's social security number (i.e., a social security number event). A data store may aggregate and store these events. In addition, the data store may store a copy of a user's submitted personal information (e.g., a submitted name, address, date of birth, social security number, phone number, gender, prior address, etc.) for comparison with the stored events. For example, an alias event may include a name that differs, in whole or in part, from the user's submitted name, an address event may include an address that differs from the user's submitted address, a phone number event may include a phone number that differs from the user's submitted phone number, and a social security number event may include multiple social security numbers found for the user. Exemplary identity events include two names associated with a user that partially match even though one name is a shortened version of the other, and a single social security number that has two names associated with it. Some identity events may be detected even if a user has submitted only partial information (e.g., a phone number or social security number event may be detected using only a user's name if multiple numbers are found associated with it).

Embodiments of the invention consider and account for statistically acceptable identity events (such as men having two or three aliases, women having maiden names, or a typical average of three or four physical addresses and two or three phone numbers over a twenty year period). In general, the comparison and correlation of a current identity event to other discovered events and to known patterns of identity theft provide an accurate assessment of the risk of the current identity event.

In addition to personally identifiable information, identity events may be subject to analysis using, for example, migratory data trends, the length of stay at an address, and the recency of the event. Census and IRS data, for example, may provide insight into how far and where users typically move within state and out-of-state. These migratory trends allow the assessment of an address event as a high, moderate, or low risk. Similarly, the length of stay at an address provides risk insights. Frequent short stays at addresses in various cities will raise concerns. Finally, the recency of the event impacts the risk level. For example, recent events are given more value than events several years old with no direct correlation to current identity events.

Each identity event may also be assigned a severity in accordance with the risk it poses. The severity level may be based on, for example, how much time would need to be spent to remediate fraud of the event type, how much money would potentially be lost from the event, and/or how badly the credit worthiness of the user would be damaged by the event. For example, a shared multiple-social security number event, wherein a user's social security number is fraudulently associated with another user (as explained further below) would be more severe than a phone number fraudulently tied to that user. Moreover, the fraudulent social security number event itself may vary in severity depending on how recently it was reported; a recent event, for example, may be potentially more severe than a several-years-old event (that had not been previously reported).

### A. Fraud Probability Score

A fraud probability score represents the likelihood that a financial event related to a user is an occurrence of identity fraud. In one embodiment, the fraud probability score is a number ranging from zero to 100, wherein a fraud probability score of zero represents a low risk of identity fraud, a fraud probability score of 100 represents a high risk of identity fraud, and intermediate scores represent intermediate risks. Any other range and values may work equally well, however, and the present invention is not limited to any particular score boundaries. The fraud probability score may be reported to a user to alert the user to an event having a high risk probability or to reassure the user that a discovered event is not a high risk. In one embodiment, as explained further below, fraud probability scores are computed and presented for financial events associated with a user who has subscribed to receive fraud probability information. Examples of fraud probability score defined ranges are presented below in Table 1.

TABLE 1
Fraud Probability Score Defined Ranges

| | Summary | |
|---|---|---|
| Range | Definition | Consumer Action |
| 0-10 | Nominal | Event is believed to be the submitted user's |
| | Risk | legitimate information |
| 11-44 | Low Risk | Event is most likely the submitted user's legitimate |
| | | information but should be reviewed and confirmed |
| 45-55 | Possible | Event is less likely the submitted user's legitimate |
| | Risk | information and the possibility of fraud should be |
| | | considered |
| 56-89 | Suspected | Event is less likely the submitted user's legitimate |
| | Risk | information, fits possible fraud patterns, and |
| | | should be closely examined |
| 90-100 | High Risk | Event does not appear to be legitimately connected |
| | | with the submitted user and fits definite fraud |
| | | patterns |

Generally, the calculation of a fraud probability score may be dependent upon one or more factors common to all types of events and/or one or more factors specific to a current event. Examples of common factors include the recency of an event; the number of occurrences of an event; and the length of time that a name, address, and/or phone number has been associated with a user. Examples of specific factors for, in one embodiment, address- and phone-related events include migration rates by age (as reported by, for example, the IRS and Census Bureau), thereby providing a probability that an address or phone change is legitimate. The Federal Trade Commission may also provide similar data specifically relevant to address- and phone-related events.

Other fraud probability score factors may be provided for financial events. Such financial events may include applications for credit cards, applications for bank accounts, loan applications, or other similar events. The personal information associated with each event may include a name, social security number, address, phone number, date of birth, and/or other similar information. The information associated with each financial event may be compared to the user's information and evaluated to provide the fraud probability score for each event.

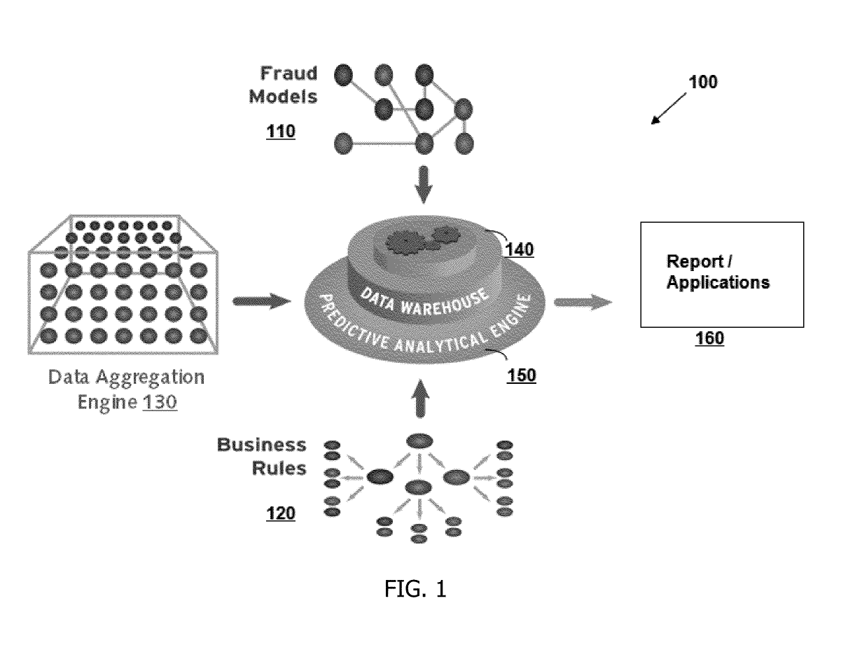

FIG. 1 illustrates an exemplary system 100 for calculating a fraud probability score and/or an identity health score, as explained further below. The system 100 includes a predictive analytical engine 150 that uses fraud models 110 and business rules 120 to correlate identity data, identify events in the identity data, compute a fraud probability score or identity health score, and determine actions to be taken, if any. The fraud models 110 characterize (e.g., assign a fraud probability score or identity health score to) events that may reflect identity misuse scenarios (e.g., a name or address identity event), as explained further below. The business rules 120 determine which fraud models 110 are most relevant for a given identity event, and direct the application of the appropriate fraud model(s) 110, as explained further below.

A data aggregation engine 130 may receive data from multiple sources, apply relevancy scores, classify the data into appropriate categories, and store the data in a data repository for further processing. The data may be received and aggregated from a number of different sources. In one embodiment, public data sources (e.g., government records and Internet data) and private data sources (e.g., data vendors) provide a view into a user's identity and asset movement. In some embodiments, it is useful to detect activity that would not typically appear on a credit report and might therefore go undetected for a long time. New data sources may be added as they become available to continuously improve the effectiveness of the service.

The analytical engine 150 analyzes the independent and highly diverse data sources. Each data source may provide useful information, and the analytical engine 150 may associate and connect independent events together, creating another layer of data that may be used by the analytical engine 150 to detect fraud activities that to date may have been undetected. The raw data from the sources and the correlated data produced by the analytical engine may be stored in a secure data warehouse 140. In one embodiment, the results produced by the analytical engine 150 are described in a report 160 that is provided to a user. Alternatively, the results produced by the analytical engine 150 may be used as input to another application (such as the online truth application described below).

It should be understood that each of the fraud models 110, business rules 120, data aggregation engine 130, and predictive analytical engine 150 may be implemented by software modules or special-purpose hardware, or in any other suitable fashion, and, if software, that they all may be implemented on the same computer, or may be distributed individually or in groups among different computers. The computer(s) may, for example, include computer memory for implementing the data warehouse 140 and/or storing computer-readable instructions, and may also include a central processing unit for executing such instructions.

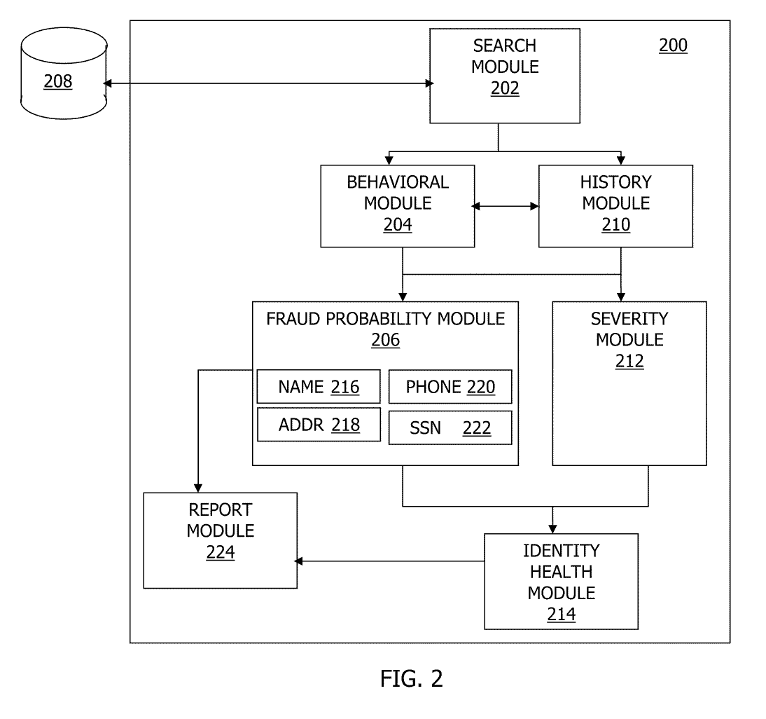

FIG. 2 illustrates a conceptual diagram of a fraud probability score calculation system 200. A search module 202 is in communication with a data store 208 that stores identity event data. Once the search module 202 identifies an identity event relevant to the user, the identity event is applied to a behavioral module 204. The behavioral module 204 includes classifications of different categories of fraudulent events (such as name, address, phone number, and social security number events, as described herein) and predictive models for each event. As described further below, the predictive models may be constructed using demographic data, research data (gleaned from, for example, identity theft experts or identity thieves themselves), examples of prior fraudulent events, or other types of data that apply to types of fraudulent events in general and are not necessarily linked specifically to the identified identity event. Using the behavioral module 204, a fraud probability module 206 computes a fraud probability score, as described in greater detail below.

In other embodiments, a history module 210 receives historical identity event data from the search module 202 and modifies the models implemented by the behavioral module 204 based on historical identity events relevant to the user. For example, a pattern of prior behavior may be constructed from the historical data and used to adjust the fraud probability score of a current identity event. A severity module 212 may analyze the identity event for a severity (e.g., the amount of harm that the event might represent if it is (or has been) carried out). An identity health module 214 may assign an overall identity health to the user based at least in part on the fraud probability score and/or the severity. The fraud probability score module 206 may contain sub-modules to compute a name 216, address 218, phone number 220, and/or social security number 222 fraud probability score, in accordance with a fraud model chosen by a business rule. A report module 224 may generate an identity health report based at least in part on the fraud probability score and/or the identity health score. The operation and interaction of these modules is explained in further detail below.

The system 200 may be any computing device (e.g., a server computing device) that is capable of receiving information/data from and delivering information/data to the user, and that is capable of querying and receiving information/data from the data store 208. The system 200 may, for example, include computer memory for storing computer-readable instructions, and also include a central processing unit for executing such instructions. In one embodiment, the system 200 communicates with the user over a network, for example over a local-area network (LAN), such as a company Intranet, a metropolitan area network (MAN), or a wide area network (WAN), such as the Internet.

For his or her part, the user may employ any type of computing device (e.g., personal computer, terminal, network computer, wireless device, information appliance, workstation, mini computer, main frame computer, personal digital assistant, set-top box, cellular phone, handheld device, portable music player, web browser, or other computing device) to communicate over the network with the system 200. The user's computing device may include, for example, a visual display device (e.g., a computer monitor), a data entry device (e.g., a keyboard), persistent and/or volatile storage (e.g., computer memory), a processor, and a mouse. In one embodiment, the user's computing device includes a web browser, such as, for example, the INTERNET EXPLORER program developed by Microsoft Corporation of Redmond, Wash., to connect to the World Wide Web.

Alternatively, in other embodiments, the complete system 200 executes in a self-contained computing environment with resource-constrained memory capacity and/or resource-constrained processing power, such as, for example, in a cellular phone, a personal digital assistant, or a portable music player.

Each of the modules 202, 204, 206, 210, 212, 214, 216, 218, 220, 222, and 224 depicted in the system 200 may be implemented as any software program and/or hardware device, for example an application specific integrated circuit (ASIC) or a field programmable gate array (FPGA), that is capable of providing the functionality described below. Moreover, it will be understood by one having ordinary skill in the art that the illustrated modules and organization are conceptual, rather than explicit, requirements. For example, two or more of the modules may be combined into a single module, such that the functions performed by the two modules are in fact performed by the single module. Similarly, any single one of the modules may be implemented as multiple modules, such that the functions performed by any single one of the modules are in fact performed by the multiple modules.

For its part, the data store 208 may be any computing device (or component of the system 200) that is capable of receiving commands/queries from and delivering information/data to the system 200. In one embodiment, the data store 208 stores and manages collections of data. The data store 208 may communicate using SQL or another language, or may use other techniques to store and receive data.

It will be understood by those skilled in the art that FIG. 2 is a simplified illustration of the system 200 and that it is depicted as such to facilitate the explanation of the present invention. The system 200 may be modified in a variety of manners without departing from the spirit and scope of the invention. For example, rather than being implemented on a single computing device 200, the modules 202, 204, 206, 210, 212, 214, 216, 218, 220, 222, and 224 may be implemented on two or more computing devices that communicate with one another directly or over a network. In addition, the collections of data stored and managed by the data store 208 may in fact be stored and managed by multiple data stores 208, or, as already mentioned, the functionality of the data store 208 may in fact be resident on the system 200. As such, the depiction of the system 200 in FIG. 2 is non-limiting.

In one embodiment, fraud probability scores are dynamic and change over time. A computed fraud probability score may reflect a snapshot of an identity theft risk at a particular moment in time, and may be later modified by other events or factors. For example, as a single-occurrence identity event gets older, the recency factor of the event diminishes, thereby affecting the event's fraud probability score. Remediation of an event may decrease the event's fraud probability score, and the discovery of new events may increase or decrease the original event's fraud probability score, depending on the type of events discovered. A user may verify that an event is or is not associated with the user to affect the fraud probability score of the event. Furthermore, modifications to the underlying analytic and predictive engines (in response to, for example, new fraud patterns) may change the fraud probability score of an event.

Financial event data may be available from several sources, such as credit reporting agencies. Embodiments of the current invention, however, are not limited to any particular source of event data, and are capable of using data from any appropriate source, including data previously acquired. Each source may provide different amounts of data for a given event, and use different formats, keywords, or variables to describe the data. In the most straightforward case, the pool of all event data may be searched for entries that match a user's name, social security number, address, phone number, and/or date of birth. These matching events may be analyzed to determine if they are legitimate uses of the user's identity (i.e., uses by the user) or fraudulent uses by a third party. The legitimate events (such as, for example, events occurring near the user's home address and occurring frequently) may be assigned a low fraud probability score and the fraudulent uses (such as, for example, events occurring far from the user's home address and occurring once) may be assigned a high fraud probability score.

Many events in the pool of all event data, however, may match the user's data only partially. For example, the names and social security numbers may match, but the addresses and phone numbers may be different. In other cases, the names, social security numbers, or other fields may be similar, but may differ by a few letters or digits. Many other such partial-match scenarios may exist. These partial matches may be collected and further analyzed to determine each partial match's fraud probability score. In general, the fraud probability score of a given event may be determined by calculating separate fraud probability scores for the name, social security number, address, and/or other information, and using the separate scores to compute an aggregate score.

The user's information and the information associated with a financial event may differ for many reasons, not all of which imply a fraudulent use of the user's identity. For example, a person entering the user's personal information for a legitimate transaction may make a typographical error. In addition, a third party may happen to have a similar name, social security number, and/or address. Furthermore, a data entry error may cause a third party's information to appear more similar to the user's information or the credit reporting agencies may mistakenly combine the records of two people with similar names or addresses. In other cases, though, the differences may imply a fraudulent use, such as when a third party deliberately changes some of the user's information, or combines some of the user's information with information belonging to other parties.

In general, real persons are more likely to have “also-known-as” names, phone numbers, and multiple addresses, to report dates of birth, and to have lived at a current address for more than one year. Identity thieves, on the other hand, tend to have no registered phone number, no also-known-as name, no reported date of birth, and a single address, and tend to have lived at that address for less than one year. Thus, a system, method, and/or apparatus that identifies some or all of these differences may be used to calculate a fraud probability score that reflects the exposure and risk to a user.

The computed fraud probability score may be presented to the user on an event-by-event basis, or the scores of several events may be presented together. In other embodiments, the fraud probability scores are aggregated into an overall identity health score, such as the identity health score described in the '798 publication. Aggregation of the fraud probability scores may result in a Poisson distribution of the health scores of the entire user population. Identity theft may be considered a Poisson process because identity theft is continuous (i.e., not discrete) and each occurrence is independent of one another.

In one embodiment, all available financial events related to a new user are searched and assigned a fraud probability score. A new user may, however, wish to view fraud probability scores from recent events. As such, financial events may be monitored in real time for subscribing or returning users, and an alert may be sent out when a high-risk event is detected.

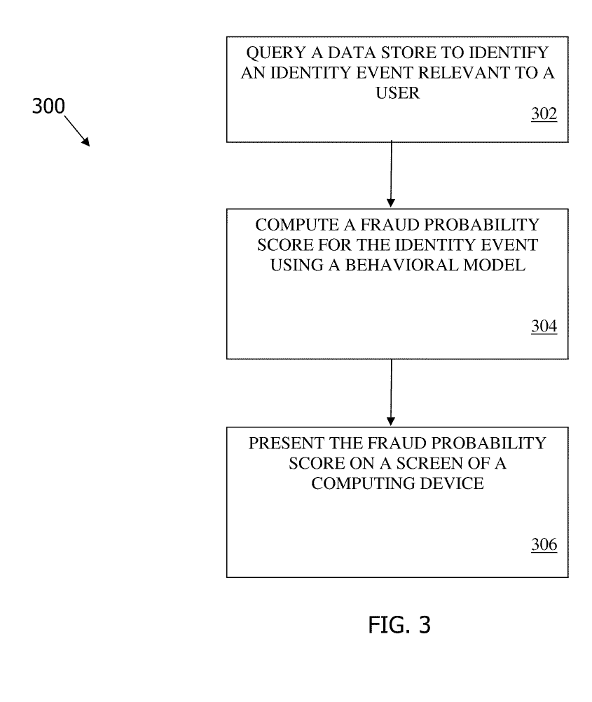

FIG. 3 illustrates, in one embodiment, a method 300 for computing a fraud probability score. In a first step 302, the data store 208 that stores identity event data is queried by the search module 202 to identify an identity event relevant to an account of a user. The event is relevant because it contains information that matches at least part of one field of information in the account of the user. In a second step 304, a fraud probability score is computed by the fraud probability module 206 for the identity event using a behavioral model provided by the behavioral module 204. The fraud probability score may be stored in computer memory or other volatile or nonvolatile storage device. In a third step 306, the report module 224 causes the presentation of the fraud probability score on a screen of an electronic device.

### A.1. Name Fraud Probability Score

In one embodiment, a name fraud probability score is calculated. In this embodiment, the data associated with a financial event matches the user's social security number, date of birth, and/or address, but the names differ in whole or in part. The degree of similarity between the names may be analyzed to determine the name fraud probability score. In general, the name fraud probability score increases with the likelihood that an event is due to identity fraud rather than, for example, a data transposition error.

In one embodiment, the names associated with one or more financial events are sorted into groups or clusters. If the user is new, the data from a plurality of financial events may be analyzed, the plurality including, for example, recent events, events from the past year or years, or all available events. Existing users may already have a sorted database of financial event names, and may add the names from new events to the existing database.

In either case, the user's name may be assigned as the primary name of a first group. Each new name associated with a new financial event may be compared to the user's name and, if it is similar, assigned as a member of the first group. If, however, the new name is dissimilar to the user's name, a new, second group is created, and the dissimilar name is assigned as the primary name of the second group. In general, names associated with new financial events are compared to the primary names of each existing group in turn and, if no similar groups exist, a new group is created for the new name. Thus, the number of groups eventually created may correspond to the diversity of names analyzed. A large number of groups may lead to a greater name fraud probability score, because the number of variations may indicate attempts at fraudulent use of the user's identity. Multiple cases of use of an identity by multiple fake names may be more indicative of employment fraud than of financial fraud. Financial fraud is typically discovered after the first fraudulent use and further fraud is stopped. Employment fraud, on the other hand, does not cause any immediate financial damage and thus tends to continue for some time before the fraud is uncovered and stopped.

An example of a name grouping procedure for a series of exemplary names is shown below in Table 2. In accordance with the above-described procedure, the names “Tom Jones” and “Thomas Jones” were judged to be sufficiently similar to be placed in the same group (Group 0). The names “Timothy Smith,” “Frank Rogers,” and “Sammy Evans” were ruled to be sufficiently different from previously-encountered names and were thus placed in new groups. The name “F. Rogers” was sufficiently similar to the previously-encountered name “Frank Rogers” to be placed with it in Group 2.

TABLE 2
Name Grouping Example

| Name Event | Assigned Group | Canonical Name |
|---|---|---|
| Tom Jones | Group 0 | Tom Jones |
| Thomas Jones | Group 0 | Tom Jones |
| Timothy Smith | Group 1 | Timothy Smith |
| Frank Rogers | Group 2 | Frank Rogers |
| F. Rogers | Group 2 | Frank Rogers |
| Sammy Evans | Group 3 | Sammy Evans |

The similarity between a new name and a primary name of an existing group may be determined by one or more of the following approaches. A string matching algorithm may be applied to the two names, and the two strings may be deemed similar if the string matching algorithm yields a result greater than a given threshold. Examples of string matching algorithms include the longest common substring (“LCS”) and the string edit distance (i.e., Levenshtein distance) algorithms. If the string edit distance is three or less, for example, the two names may be deemed similar. As an illustrative example, an existing primary group name may be BROWN and a new name may be BRAUN. These names are within two edit distances because two letters in BROWN, namely O and W, may be changed (to A and U, respectively) in order for the two names to match. Thus, in this example, BRAUN is sufficiently similar to BROWN to be placed in the same group as BROWN.

An exception to the string edit distance technique may be applied for transposed characters. For example, the names BROWN and BRWON may be assigned a string edit distance of 0.5, instead of two, as described above, because the letters O and W are not changed in the name BRWON, but merely transposed (i.e., each occurrence of transposed characters are assigned a string-edit distance of 0.5). This lower string edit distance may reflect the fact that such a transposition of characters is more likely to be the result of a typographical mistake, rather than a fraudulent use of the name.

Another string matching technique may be applied to first names and nicknames. The name or common nicknames of the new name may be compared to the name or common nicknames of the existing primary group name to determine the similarity of the names. Some nicknames are substrings of full first names, such as Tim/Timothy or Chris/Christopher, and, as such, the LCS algorithm may be used to compare the names. In one embodiment, a ratio of length of the longest common substring is compared to the length of the nickname, and the names are deemed similar if the ratio is greater than or equal to a given threshold. For example, an LCS-2 algorithm having a threshold of 0.8 may be used. In this example, Tim matches Timothy because the longest common substring, T-I-M, is greater than two characters, and the ratio of the length of the longest common substring (three) to the length of the nickname (three) is 1.0 (i.e., greater than 0.8).

Other nicknames, however, do not share a common substring with their corresponding full name. Such nicknames include, for example, Jack/John and Ted/Theodore. In these cases, the name and nickname combinations may be looked up in a predetermined table of known nicknames and corresponding full first names and deemed similar if the table produces a match.

Finally, a new name may be deemed similar to an existing primary group name if the first and last names are the same but reversed (i.e., the first name of the new name is the same as the last name of the existing primary group name, and vice versa). In one embodiment, the reversed first and last names are not identical but are similar according to the algorithms described above.

Different name matching algorithms may be used depending on the gender of the names, because, for example, one gender may be more likely than the other to change or hyphenate last names upon marriage. In this case, if a last name is wholly contained in a canonical last name, and the canonical last name contains a hyphen or forward slash, the last name may be placed in the same group as the canonical last name. In one embodiment, a male name receives a low similarity score if a first name matches but a last name does not, while a female name may receive a higher similarity score in the same situation. A male name, for example, may be similar if it has a substring-to-nickname length ratio of 0.7, while for a female name, the ratio may instead be 0.67.

A name fraud probability score may be assigned to the new name once it has been added to a group. In one embodiment, the name fraud probability score depends on the total number of groups. More groups imply a greater risk because of the greater variety of names. In addition, the name fraud probability score may depend on the number of names within the selected group. More names in the selected group imply less risk because there is a greater chance that the primary group name belongs to a real person.

If the associated names do not belong to real people, the case of one name without any also-known-as names (“AKAs”) is likely to be a case of new-account financial fraud. If, on the other hand, multiple name groups are found, the fraud type may be non-financial-related (e.g., employment-related). Because non-financial-related fraud is perpetrated for a longer period, it is more likely that AKAs will accumulate. In one embodiment, new-account fraud is deemed more serious than non-financial-related fraud. Finally, the case of one group and multiple AKAs is also presumed to be non-financial fraud, but because only a single identity is involved, it is presumed to be the least serious of all cases.

If the associated names do belong to real people, the case of one name without any AKAs is presumed to be a one-time inadvertent use of another person's social security number due to, for example, a data entry or digit transposition error. A single name with two or three AKAs indicates that the associated person may have made the same mistake more than once. Another possibility is that the credit bureau has merged this person with the user and thus the user's credit score is affected.

Multiple groups, regardless of the number of AKAs, may indicate a social security number that commonly results in transposition or data entry errors. For example, the digit 6 may be mistakenly read as an 8 or a 0, a 5 may become a 6, and/or a 7 may become a 1 or a 9. Even though these types of errors may be unintentional and made without deceptive intent, more people in a group may increase the likelihood that a member of the group may, for example, default on a loan or leave behind a bad debt, thus affecting the user in some way.

Moreover, the name fraud probability score may be modified by other variables, such as the presence or absence of a valid phone or social security number. In one embodiment, the existence of a valid phone number is determined by matching the non-null and non-zero permid of the name matching against the permid in the identity_phone table. The permid is the unique identifier linking multiple header records (e.g., name, address, and/or phone) together where it is believed that these records all represent the same person. When the headers are disassembled, the permid is retained so that attributes may be grouped by person. Two exemplary embodiments of name fraud probability score computation algorithms are presented below.

### A.1.a First Exemplary Name Probability Fraud Score Calculation Algorithm

Tables 3A and 3B show examples of risk category tables for use in assigning a name fraud probability score, wherein Table 3A corresponds to a new name record with no associated valid phone number, and Table 3B corresponds to a new record with a valid phone number. Each table assigns a letter A-G to each row and column combination, and each letter corresponds to an initial value. In one embodiment, A=0.9, B=0.8, C=0.7, D=0.65, E=0.55, F=0.5, and G=0.45. Different numbers of letters and/or different values for each letter are possible, and the embodiments described herein are not limited to any particular number of letters or values therefor. The assigned letters are used, as described below, in assigning a name fraud probability score.

TABLE 3A
Names with No Associated Phone

| | |
|---|---|
| Number of Occurrences | Number of Groups |

| within the Selected Group | 1 | 2 | 3 | >3 |
|---|---|---|---|---|
| 1 | A | B | B | B |
| 2 | C | B | B | B |
| 3 | C | B | B | B |
| >3 | C | B | B | B |

TABLE 3B
Names with an Associated Phone

| | |
|---|---|
| Number of Occurrences | Number of Groups |

| within the Selected Group | 1 | 2 | 3 | >3 |
|---|---|---|---|---|
| 1 | G | D | D | D |
| 2 | F | D | D | D |
| 3 | E | D | D | D |
| >3 | D | D | D | D |

Once the discovered name events are assigned to relevant groups, the next step is to determine the most recent Last Update (i.e., the most recent date that the name and address were reported to the source) and the oldest First Update (i.e., the first date the name and address were reported to the source) for each group having more than one name assigned to it. A collision is defined as two similar names having different date attributes, and this step may address any attribute collisions within the group and determine the recency and age for the entire name group. For example, using the exemplary groups listed in Table 2, the name events “Thomas Jones” and “Tom Jones” are both assigned to Group 0. The name event “Thomas Jones” may have a first update of 200901 and a last update of 200910, for example, while the name event “Tom Jones” may have a first update of 200804 and a last update of 200910. Thus, because the dates differ, the names “Thomas Jones” and “Tom Jones” collide. In one embodiment, the earliest found first update date is considered the oldest date for the name group and the latest discovered update date is considered the most recent date for the group. In this case, the name group date span is 200804 to 200910. Other methods of resolving collisions exist, however, and are within the scope of the current invention.

Table 4 illustrates exemplary name fraud probability score calculations, given the assignment of a letter as described in Tables 3A-3B. The length of stay may be determined by subtracting the date that the new name was first reported from the date of the financial event (i.e., the length of time that the name had been in use before the date of the financial event), and the last update is the number of days from the last activity associated with the name. In some embodiments, the reported financial event data includes only the month and year for the first reported and event dates, and a day of the month is assumed to be, for example, the fifteenth. Where collisions occur, as described above, first updated may be the oldest date and last updated may be the most recent date.

TABLE 4
Name Fraud Probability Score Calculations

| | Length of | Last Update | Name Fraud Probability |
|---|---|---|---|
| Category | Stay (Days) | (Days) | Score |
| A | 0 | ≦183 | ³\sqrt{A} |
| | <61 | ≦183 | \sqrt{A} |
| | <183 | ≦183 | A |
| | <366 | ≦183 | A |
| | <1096 | ≦183 | 2A − \sqrt{A} |
| | 0 | >183 | A |
| | all else | any | 2A − ³\sqrt{A} |
| B | >92 | <29 | \sqrt{B} |
| | >92 | ≧29 and <35 | \sqrt{B × \sqrt{B}} |
| | >92 | ≧35 | B |
| | ≦92 | any | 2B − \sqrt{B} |
| C, D, E, F, G | >92 | ≦183 | \sqrt{C, D, E, F, G} |
| | >92 | >183 | C. D, E, F, G |
| | ≦92 | any | 2(C, D, E, F, G) − |
| | | | \sqrt{C, D, E, F, G} |

In one example of the above, an existing set of groups associated with a user's name contains two groups, and each group contains three names. A new financial event is detected wherein the name associated with the financial event matches the primary name of the second group, there is no associated phone number, the length of stay is 50 days, and the information was last updated 25 days ago. Because the new financial event does not have an associated phone number, Table 3A is used to determine that probability B is assigned. Referring next to Table 4, probability B falls into Category B. The example length of stay and last update (50 days and 25 days, respectively) fall under the last line of this category, so the final name fraud probability score is 2B−\sqrt{B}. If B=0.8, as above, the name fraud probability score is approximately 0.706, or 70.6%.

In some embodiments, after aggregation of the names, there is only one group. In these embodiments, events whose names do not match the group's primary name are assigned a name fraud probability score according to Table 5.

TABLE 5
Name Fraud Probability Scores

| Relationship Between the Name | Name Fraud |
|---|---|
| Associated with the Event and | Probability Score |
| the Group Primary Name | (%) |
| Differs in middle name | 10 |
| First, last names reversed | 12 |
| First name matches; last name is substring | 12 |
| First name matches; last name within edit distance | 12 |
| of three | |
| First name matches; last name not within edit distance | 15 |
| of three | |
| First name matches; last name does not match | 20 |
| First, last names reversed; first name does not match; | 25 |
| last name is within edit distance of three | |

### A.1.b Second Exemplary Name Probability Fraud Score Calculation Algorithm

In another embodiment, name events in the first group (i.e., the group to which the user's name is assigned as the primary name, such as Group 0 in the above examples) may be assigned a fraud probability score in accordance with matching first, last, and (if available) middle names. In this embodiment, names that are identical to the submitted user's name are assigned a fraud probability score of zero, names that are reasonably certain to be the user are assigned a fraud probability score less than or equal to ten (including names in which only the first initial is provided but is a match), and names in which only the last name matches are assigned a fraud probability score of 30. Table 6 illustrates a scoring algorithm for assigning a fraud probability score (FPS) to various name event permutations.

TABLE 6
Name Fraud Probability Score Assignments

| First | Middle | Last | FPS |
|---|---|---|---|
| Exact | Different | Exact | 3 |
| Exact | Different | Different | 6 |
| Soft | Different | Different | 8 |
| Soft | Different | Soft | 8 |
| Different | Different | Exact | 25 |
| Different | Different | Soft | 30 |
| Exact | Exact | Different | 5 |
| Initial only | (not provided) | Exact | 8 |
| Initial only | (not provided) | Soft | 9 |
| Soft or exact match last | (not provided) | Soft or exact match | 5 |
| name | | first | |
| Soft or exact | (not provided) | Contained in last name | 6 |
| Soft or exact match of | (not provided) | Different | 30 |
| last name | | | |

In the scoring algorithm illustrated in Table 6, an exact match is defined as a match having a string-edit distance of zero. Two first names may be regarded as an exact match, even if their string-edit distance is greater than zero, if they are known nicknames of the same name or if one is a nickname of the other. A soft match of a last name is defined as a match having a string-edit distance of three or less, and a soft match of a first name is defined as a match having a longest common substring of at least two and a longest-common-substring-divided-by-shortest-name value of at least 0.63. For example, using the names “Kristina” and “Christina,” the longest common substring value is seven (i.e., the length of the substring “ristina”), and the shortest name value is eight (i.e., the length of the shorter name “Kristina”). The longest-common-substring-divided-by-shortest-name value is therefore 7÷8 or 0.875, which is greater than 0.63, and the names are therefore a soft match. Note that, even if the first names were not a soft match under the foregoing rule, they may still be considered a soft match if their string-edit distance is less than 2.5 (where each occurrence of transposed characters is assigned a string-edit distance of 0.5).

In one embodiment, names assigned to groups other than the first group (e.g., Group 1, Group 2, etc.) may be assigned different fraud probability scores. As explained above, these names may be considered higher risks because of their greater difference from the submitted user's name used in the first group (e.g., Group 0). If a phone number is associated with a name, however, that may indicate that the name belongs to a real person and thus lessen the risk of identity theft associated with that name. Thus, the groups may be divided into names with no associated phone number, representing a higher risk, and names with associated phone numbers, representing a lower risk. Tables 7A and 7B, below, illustrate a method for assigning a fraud probability score to these names.

TABLE 7A
Name Risk Categories (No Phone)

| | |
|---|---|
| # of Names | Name Group |

| Within Group | Group 1 | Group 2 | Group 3 | Group 4 |
|---|---|---|---|---|
| 1 | 90 | 80 | 80 | 80 |
| 2 | 70 | 80 | 80 | 80 |
| 3 | 70 | 80 | 80 | 80 |
| >3 | 70 | 70 | 80 | 80 |

TABLE 7B
Name Risk Categories (With Phone)

| | |
|---|---|
| # of Names | Name Group |

| Within Group | Group 1 | Group 2 | Group 3 | Group 4 |
|---|---|---|---|---|
| 1 | 45 | 65 | 65 | 65 |
| 2 | 50 | 65 | 65 | 65 |
| 3 | 55 | 65 | 65 | 65 |
| >3 | 65 | 65 | 65 | 65 |

In one embodiment, the fraud probability scores listed in Tables 7A and 7B are adjusted in accordance with other factors, such as length of stay and recency, as described above. In general, the fraud probability scores in Table 7B increase from the upper-left corner of the table to the lower-right corner of the table to reflect the increasing likelihood that a user's identity (represented, for example, by the user's social security number) is being abused, rather than a difference merely being the result of a data entry error.

### A.2. Social Security Number Fraud Probability Score

In one embodiment, a social security number fraud probability score is calculated when more than one social security number is found to be associated with a user (i.e., a multiple social security number event). The pool of partially matching financial event data may include entries that match on name, date of birth, etc., but have different social security numbers. Just as with the name fraud probability score, the social security number fraud probability score may reflect the likelihood that the differing social security numbers reflect a fraudulent use of a user's identity.

The social security numbers may differ for several reasons, some benign and some malicious. For example, digits of the social security number may have been transposed by a typographical error, the user may have co-signed a loan with a family member and the family member's social security number was assigned to the user, and/or the user has a child or parent with a similar name and was mistaken for the child or parent. On the other hand, however, the user's name and address may have been combined with another person's social security number to create a synthetic identity for fraudulent purposes. The social security number fraud probability score assigns a score representing a low risk to the former cases and a score representing a high risk to the latter. In one embodiment, a typographical error in a user's social security number leads to the resultant number being erroneously associated with a real person, even though no identity theft is attempted or intended; in this case, the fraud probability score may reflect the lowered risk.

One type of identity theft activity involves the creation of a synthetic identity (i.e., the creation of a new identity from false information or from a combination of real and false information) using a real social security number with a false new name. In this case, a single social security number may be associated with the user's name and a second, fictional name. This scenario is typically an indication of identity fraud and may occur when a social security number is used to obtain employment, medical services, government services, or to generate a “synthetic” identity. Although these fraudulent activities involve a social security number, they are generally handled as name fraud probability score events, as described above.

In some embodiments, full social security numbers are not available. Some financial event reporting agencies report social security numbers with some digits hidden, for example, the last four digits, in the format 123-45-XXXX. In this case, only the first five numbers may be analyzed and compared. In other embodiments, financial event reporting agencies assign a unique identifier to each reported social security number, thereby hiding the real social security number (to protect the identity of the person associated with the event) but providing a means to uniquely identify financial events. In these embodiments, the unique identifiers are analyzed in lieu of the social security numbers, or, using the reporting agencies' algorithms, translated into real social security numbers. Alternatively, two social security numbers with the same first five digits but different unique identifiers may be distinguished by assigning different characters to the unknown digits, e.g., 123-45-aaaa and 123-45-bbbb.

In one embodiment, the social security number fraud probability score is computed with a string edit distance algorithm and/or a longest common substring algorithm. First, a primary social security number is selected from the group of financial events having similar social security numbers. This primary or “canonical” social security number may be the social security number with the most occurrences in the group. If there is more than one such number, the social security number with the longest length of stay, as defined above, may be chosen.

Next, the rest of the social security numbers in the group are compared to the primary number with the string edit distance and/or longest common substring algorithms, and the results are compared to a threshold. Numbers that are deemed similar are assigned a first fraud probability score, and dissimilar numbers a second. The first and second fraud probability scores may be constants or may vary with the computed string edit distance and/or the length of the longest common substring.

In one embodiment, the social security numbers (or available portions thereof) are similar if they have a string edit distance of one (where transposed digits receive a string edit distance of 0.5, as described above) or if they have a longest common substring of four. In this embodiment, similar social security numbers receive a constant fraud probability score of 25% and dissimilar numbers receive a fraud probability score according to the equation:

Fraud Probability Score=String Edit Distance÷Digits×65%+25% (1)

where Digits is the number of visible digits in the social security numbers. In one embodiment, Digits is 5.

In another embodiment, a comparison algorithm is tailored to a common error in entering social security numbers wherein the leading digit is dropped and an extra digit is inserted elsewhere in the number. In this embodiment, the altered social security number may match a primary social security number if the altered number is shifted left or right one digit. The two social security numbers may therefore be similar if four consecutive digits match. For example, the primary number may be 123-45-6789 the altered number 234-50-6789, wherein the leading 1 is dropped from the primary number and a 0 is inserted in the middle. If the altered number is shifted one digit to the right, however, the resulting number, x23-45-0678, matches the primary number's “2345” substring. In one embodiment, a string of four similar characters is the minimum to declare similarity.

Social security numbers that are deemed to be similar are assigned an appropriate fraud probability score, e.g., 25%. If a discovered social security number is different from the primary or canonical social security number, its fraud probability score is modified to reflect the difference. In one embodiment, the different social security number receives a fraud probability score in accordance with the equation:

Fraud Probability Score=String Edit Distance÷5×65%+25% (2)

where the string edit distance is computed between the first five digits of the compared social security numbers.

In an alternative embodiment, instead of designating a primary social security number and comparing the rest of the numbers to it, the social security numbers are compared one at a time to each other, and either placed in a similar group or used to create a new group. In this embodiment, the social security number groups are similar to the name groups described above, and the social security number fraud probability score may be computed in a manner similar to the name fraud probability score.

### A.3. Address Fraud Probability Score

In one embodiment, an address fraud probability score is calculated. The address fraud probability score reflects the likelihood that a financial event occurring at an address different from the user's disclosed home address is an act of identity theft. To compute this likelihood, the two addresses may be compared against statistical migration data. If the user is statistically likely to have moved from the home address to the new address, then the financial event may be deemed less likely an act of fraud. If, on the other hand, the statistical migration data indicates it is unlikely that the user moved to the new address, the event may be more likely to be fraudulent.

Raw statistical data on migration within the United States is available from a variety of sources, such as the U.S. Census Bureau or the U.S. Internal Revenue Service. The Census Bureau, for example, publishes data on geographical mobility, and the Internal Revenue Service publishes statistics of income data, including further mobility information. The mobility data may be sorted by different criteria, such as age, race, or income. In one embodiment, data is collected according to age in the groups 18-19 years; 20-24 years; 25-29 years; 30-34 years; 35-39 years; 40-44 years; 45-49 years; 50-54 years; 55-59 years; 60-64 years; 65-69 years; 70-74 years; 75-79 years; 80-84 years; and 85+ years.

In one embodiment, address-based identity events are categorized as either single-address occurrences (i.e., addresses that appear only once in a list of discovered addresses for a given user and were received from a single dataset) or multi-address occurrences (i.e., a set of identical or similar addresses). In one embodiment, single-address occurrences are more likely to be an address where the user has never resided. Multi-address occurrences may be grouped together to obtain normalized length-of-stay and last-updated data for the grouped addresses. For example, the length-of-stay and last-updated data may be averaged across the multi-address group, outlier data may be thrown out or de-emphasized, and/or data deemed more reliable may be given a greater emphasis in order calculate a single length-of-stay and/or last-updated figure that accurately represents the multi-address group. Once the data is normalized, it may then be applied against the single-address occurrences to estimate fraud probabilities. Length-of-stay data and event age, as denoted by last-updated data, may be important factors in assigning a fraud probability score, as explained in greater detail below. In one embodiment, the grouping process also yields the number of discovered addresses that are different from the submitted address, which may be used to compute an overall fraud probability score. Address identity events that are directly tied to a name that is not the submitted user's name, however, may not be included in the address grouping exercise.

The discovered addresses may be analyzed and grouped into single and multiple occurrences by comparing a discovered address to the user's primary address (and previous addresses, if submitted) using, e.g., a Levenshtein string distance technique. Each discovered address may be broken down into comparative sub-components such as house number, pre-directional/street/suffix/post-directional, unit or apartment number, city, state, county, and/or ZIP code. Addresses determined to be significantly different than the submitted address may be considered single-occurrence addresses and receive a fraud probability score reflecting a greater risk. The fraud probability score may be modified by other factors, such as the length-of-stay at the address and the age of the address. In one embodiment, the shorter the length of stay and the newer the address, the more risk the fraud probability score will indicate. For addresses within the multi-address occurrence group, migration data may be determined based on the likelihood of movement between the submitted address and event ZIP code.

In one embodiment, single-occurrence addresses are assigned a fraud probability score based upon length of stay and age of the address. Generally, the shorter the length of stay at an address and the newer the address, the higher the probability of identity fraud. Table 8, below, provides fraud probability scores for single-occurrence addresses based on their specific age and the length of stay at the time of address pairing. The age of an address is defined as the difference between the recorded date of the address within the data set and the date of its most recent update; length of stay is defined as the difference between the first and last updates associated with the address. For example, on Jul. 10, 2010 (the date of the most recent update), an address identity event may indicate a single-occurrence address having a first reported date of Jun. 15, 2009 (the recorded date/first update), and a latest update associated with the address identity event of Jun. 1, 2010 (the latest update). The age of the address is thus 390 days (Jun. 15, 2009 to Jul. 10, 2010) and the length of stay is 351 days (Jun. 15, 2009 to Jun. 1, 2010). The fraud probability score associated with this event, with reference to Table 8, is thus 65.

TABLE 8
Address Fraud Probability Scores

| | Length of Stay | Fraud Probability |
|---|---|---|
| Age (Days) | (Days) | Score (FPS) |
| <365 | <181 | 85 |
| >365 and <730 | <181 | 75 |
| >730 and <1095 | <181 | 65 |
| >1095 and <1460 | <181 | 55 |
| >1460 | <181 | 45 |
| >1460 | >181 | 35 |
| >1095 and <1460 | >181 | 45 |
| >730 and <1095 | >181 | 55 |
| >365 and <730 | >181 | 65 |
| <365 | >181 | 75 |

If a single address lacks both an age and length of stay, the fraud probability score for that address may be computed based on migration data as follows:

Fraud Probability Score=(2×Km×MR)+(50−Km) (3)

where Km is 5 and MR is the migration rate to the address from the user's primary address. Addresses having errors but that are similar to valid user addresses may be grouped with the valid user addresses and are therefore multi-occurring. Multi-occurrence addresses may be given lower fraud probability scores than single-occurrence addresses in accordance with the equation:

Fraud Probability Score=35×MR+K (4)

where MR is the migration rate to the address from the user's primary address and K is 0. An address associated with a different name may be assigned the same fraud probability score as the unrelated name using the algorithm for the name fraud probability score described above.

In addition, the total number of discovered addresses may affect the overall measure of identity health (i.e., the overall identity health score). Although a fraud probability score may not be high for a single detected address event, the presence of several address events may lead to a lower identity health score. As described above, many users may have between three and four physical addresses during a twenty year period, and the computation of the identity health score reflects this normalized behavior. As a result, a user having fifteen prior addresses in twenty years may have a lower identity health score than a user having only three prior addresses in twenty years. The difference reflects that a person who moves frequently may leave behind a paper trail, such as personal information appearing in non-forwarded mail, that may be used to commit identity theft.

In one embodiment, the moves are further categorized by age bracket. In another embodiment, migration data for overseas addresses, such as Puerto Rico and U.S. military addresses (i.e., APO and FPO addresses), is included in the raw migration data. Using the raw migration data, the migration rate may be calculated for each state-to-state move, and, for moves within a state, each county-to-county move.

The migration rate data may be modulated with the known migration patterns of subscribed users. This modulation may account for the possibility that the migration pattern of people concerned about identity theft may be different than that of the population as a whole.

In one embodiment, the address fraud probability score is computed as the inverse of the migration rate. The computed address fraud probability score information may be used with the migration rate data to populate database tables for later use. The fields of the tables may include an age bracket, the state/county of origin, the destination state/county, and the fraud probability score itself. The to/from state/county fields may be provided using the Federal Information Processing Standard (“FIPS”) codes for each state and county, or any other suitable representation of state and county data. The database tables may be updated as new information becomes available, for example, annually.

Table 9 illustrates a partial table for inter-county moves for South Carolina (having a FIPS code of 45). To give one particular example, for someone aged 42 at the time of a move from Abbeville County (having FIPS code of 001) to Anderson County (having a FIPS code of 007), the address fraud probability score is 51.51%.

TABLE 9
Example Table for Inter-County Moves

| | | | | | | Address |
|---|---|---|---|---|---|---|
| | | | | | | Fraud |
| | From | From | | | | Probability |
| Age Group | State | County | To State | To County | State | Score |
| 40-44 | 45 | 001 | 45 | 007 | SC | 51.51 |
| 35-39 | 45 | 001 | 45 | 007 | SC | 51.52 |
| 55-59 | 45 | 001 | 45 | 007 | SC | 48.72 |
| 30-34 | 45 | 001 | 45 | 007 | SC | 50.63 |
| 45-49 | 45 | 001 | 45 | 007 | SC | 51.83 |
| 20-24 | 45 | 001 | 45 | 007 | SC | 51.17 |
| 75-79 | 45 | 001 | 45 | 007 | SC | 57.38 |
| 25-29 | 45 | 001 | 45 | 007 | SC | 51.10 |
| 50-54 | 45 | 001 | 45 | 007 | SC | 50.32 |
| 60-61 | 45 | 001 | 45 | 007 | SC | 50.43 |
| 62-64 | 45 | 001 | 45 | 007 | SC | 53.41 |
| 70-74 | 45 | 001 | 45 | 007 | SC | 46.13 |
| 85+ | 45 | 001 | 45 | 007 | SC | 48.61 |

### A.4. Phone Fraud Probability Score

In one embodiment, a phone fraud probability score is calculated. In this embodiment, a phone number is converted into a ZIP code, and the ZIP code is converted into a state and county FIPS code. Using the state and county FIPS codes, the phone fraud probability score may then be computed like the address fraud probability score, as explained above. Tables 10 and 11 illustrate sample conversions using the North American Number Plan phone number format, wherein a phone number is separated into a numbering plan area (“NPA”) section (i.e., the area code) and a number exchange (“NXX”) section. The numbering plan area section provides geographic data at the state and city level, and the number exchange provides geographic data at the inter-city level. For example, the phone number 407-891-1234 has an NPA of 407 (corresponding to the greater Orlando area) and an NXX of 891. Using this example and Table 10, the phone number is converted into a ZIP code 34744. Table 11 shows how this exemplary ZIP code may be converted into state and county FIPS codes 12 and 097. This state and county data may be compared to a user's disclosed state and county, or, if none are given, the user's phone number may be converted into state and county data with a similar method. In one embodiment, a table similar to Table 9 above may be employed to determine the phone fraud probability score. In another embodiment, if a discovered phone event is directly tied to a name via a common data source identifier value and that name has a higher fraud probability score than the phone event, the fraud probability score associated with the name is assigned to that phone event. Furthermore, phone events attached to a single address may be assigned the same fraud probability score as that address. Other phone events may be assigned a fraud probability score based on migration data in accordance with the following equation:

FPS=35×MR+K (5)

TABLE 10
ZIP Code Assignments

| Phone Number | Area Code (NPA) | Exchange (NXX) | Zip Code |
|---|---|---|---|
| (407) 888-1234 | 407 | 888 | 32806 |
| (407) 889-1234 | 407 | 889 | 32703 |
| (407) 891-1234 | 407 | 891 | 34744 |
| (407) 892-1234 | 407 | 892 | 34769 |
| (407) 893-1234 | 407 | 893 | 32801 |
| (407) 894-1234 | 407 | 894 | 32801 |
| (407) 895-1234 | 407 | 895 | 32801 |
| (407) 896-1234 | 407 | 896 | 32801 |
| (407) 897-1234 | 407 | 897 | 32801 |
| (407) 898-1234 | 407 | 898 | 32801 |
| (407) 899-1234 | 407 | 899 | 32801 |

TABLE 11
State and Country FIPS Codes Assignments

| ZIP Code | State FIPS code | County FIPS code | State |
|---|---|---|---|
| 34740 | 12 | 095 | FL |
| 34741 | 12 | 097 | FL |
| 34742 | 12 | 097 | FL |
| 34743 | 12 | 097 | FL |
| 34744 | 12 | 097 | FL |
| 34745 | 12 | 097 | FL |
| 34746 | 12 | 097 | FL |
| 34747 | 12 | 097 | FL |

### B. Identity Health Score

In one embodiment, an identity health score is an overall measure of the risk that a user is a victim (or potential victim) of identity-related fraud and the anticipated severity of the possible fraud. In other words, the identity health score is a personalized measure of a user's current overall fraud risk based on the identity events discovered for that user. The identity health score may serve as a definitive metric for decisions concerning remedial strategies. The identity health score may be based in part on discovered identity events (e.g., from a fraud probability score) and the severity thereof, user demographics (e.g., age and location), and/or Federal Trade commission data on identity theft.

Although the identity health score may be dependant on an aggregate of the fraud probability score, it may not be an absolute inverse of the sum of each fraud probability score. Instead, the identity health score may be computed using a weighted average that also incorporates an element of severity for specific fraud probability score events, as described above. In addition, identity events having a low-risk fraud probability score may still have a large impact on the overall identity health score. For example, a larger number of low-fraud-probability-score identity events may impact the overall identity health score to the same or greater degree as a small number of identity events having high fraud probability score values. The identity health score metric, like the fraud probability score, may be based on a range of zero to 100, where a score of zero indicates the user is most at risk of becoming a victim of identity theft and a score of 100 indicates the user is least at risk. Table 12 illustrates exemplary ranges for interpreting identity health scores; the ranges, however, may vary to reflect changing market data and risk model results.

TABLE 12
Identity Health Score Defined Ranges

| | Summary | |
|---|---|---|
| Range | Definition | Consumer Action |
| 0-10 | High Risk | Immediate action required. All discovered events |
| | | should be closely examined and other actions may |
| | | be warranted. |
| 11-44 | Suspected | Prompt action required. All discovered events |
| | Risk | should be closely examined. |
| 45-55 | Possible | Vigilance recommended. At a minimum, all high |
| | Risk | fraud probability score events should be closely |
| | | examined. |
| 56-89 | Low Risk | Although risk appears low at this time, all high |
| | | fraud probability score events should be reviewed. |
| 90-100 | Nominal | No user is immune to identity risk, but at this time |
| | Risk | risk appears minimal. |

The identity health score may be calculated as a composite number using one of the two below-described formulas, utilizing fraud probability score deviations of event components, user demographics, and fraud models. In one embodiment, if a high-risk fraud probability score (e.g., greater than 80) is detected, the identity health score may equal to the inverse (i.e., the difference from the total score of 100) of that fraud probability score:

Identity Health Score=100−MAX(Fraud Probability Score) (6)

For example, a fraud probability score of 85 produces an identity health score of 15. Thus, a discovered event having a high fraud probability is addressed immediately regardless of the fraud probability score levels of other events.

If, on the other hand, each detected identity event has a fraud probability score value less than 80, the identity health score may be computed in accordance with the following equation:

Identity Health Score=0.9×Event Component+0.1×Demographic Component (7)

where

$$Event Component = Arctangent ( \frac{43}{Fvm\_magnitude} ) \times \frac{57.2957795}{0.9} \qquad ( 8 )$$

and

$$\begin{matrix}Fvm\_magnitude = {\sum }_{i = 1}^{n} 5 \times sin ( \frac{\begin{matrix}{address\_fps}_{i} \times 0.9 \times \\ 2 \times 3.1415\end{matrix}}{360} ) + \\ {\sum }_{i = 1}^{n} 8 \times sin ( \frac{\begin{matrix}{name\_fps}_{i} \times 0.9 \times \\ 2 \times 3.1415\end{matrix}}{360} ) + \\ {\sum }_{i = 1}^{n} 3 \times sin ( \frac{\begin{matrix}{phone\_fps}_{i} \times 0.9 \times \\ 2 \times 3.1415\end{matrix}}{360} ) + \\ {\sum }_{i = 1}^{n} 4 \times sin ( \frac{\begin{matrix}{multissn\_fps}_{i} \times 0.9 \times \\ 2 \times 3.1415\end{matrix}}{360} )\end{matrix} \qquad ( 9 )$$

where, address_fps is the computed address fraud probability score, name_fps is the computed name fraud probability score, phone_fps is the computed phone fraud probability score, and multissn_fps is the computed social security number fraud probability score.

Demographic Component may be a constant that is based on the current age of the submitted user and their current geographic location. Using this formula, the event component may be responsible for approximately 90% of the overall identity health score, while the demographic component provides the remainder. In other words, the weighted aggregate of the individually calculated fraud probability scores may influence the final identity health score by 90% based on the computation of the Fvm_magnitude variable. As the formula for that variable indicates, different identity event types are assigned different impact weights (i.e., an address identity event receives a weight of 5, a name identity event a weight of 8, a phone identity event a weight of 3, and a multi-social-security-number identity event a weight of 4. The present invention is not limited to any particular weight factors, however, and other factors are within the scope of the invention. The total number of each event type (indicated by the Σ symbol) may impact the overall computed value. Therefore, the computation of the identity health score algorithm is built such that the type of event—and the total number of events within a specific event type (greater than the typical number of expected total number for the event type)—impact the overall identity health score accordingly.

The identity health score may be reduced proportionally if the number of single occurring name, address, and phone identity events (represented by the variable “EventCount” in the formula below) is greater than three. The greater the single occurring event count, the higher the applied reduction, in accordance with the following formula:

$$Reduction = 1 - {e}^{\frac{- {k}_{i}}{EventCount - 3}} \qquad ( 10 )$$

where kᵢ=3. In one embodiment, the identity health score is reduced by multiplying it with this reduction factor.

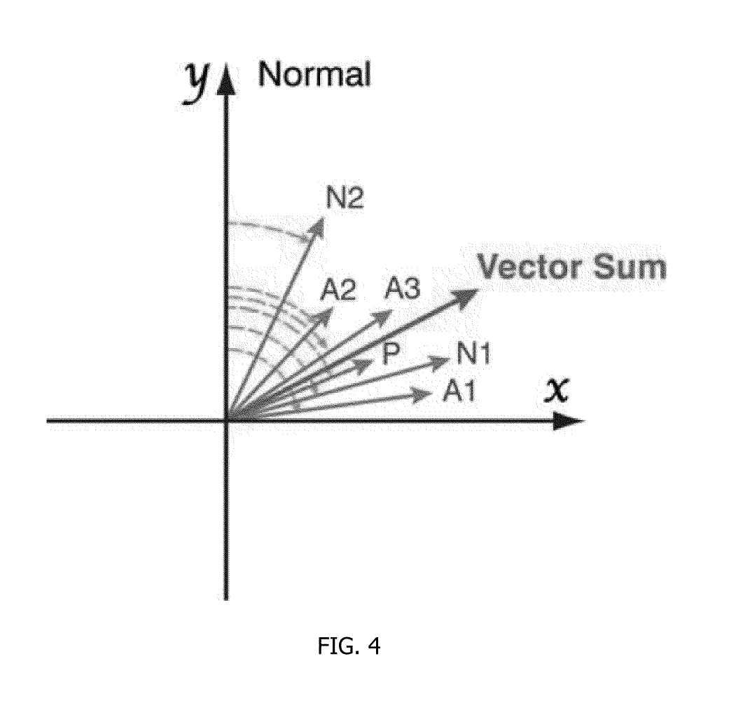

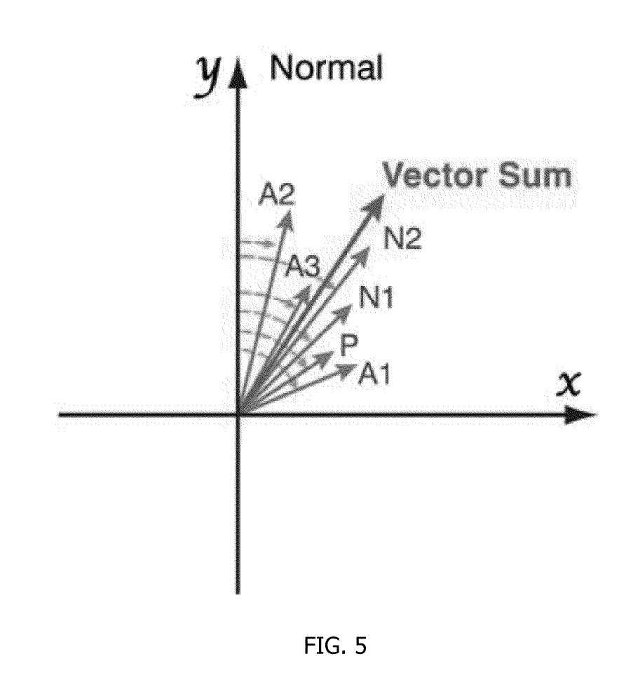

FIGS. 4 and 5 illustrate fraud probability scores, using vector diagrams, for two different users. In the figures, N-vectors denote name events, A-vectors denote address events, and P-vectors denote phone events. In one embodiment, the x-axis represents fraud and the y-axis represents no fraud. The associated angle of each event relative to the y-axis corresponds to that event's fraud probability score, wherein a greater angle from vertical corresponds to a greater fraud probability, and the length of each vector represents the associated severity of the event. The length of the vector sum obtained by adding all of the event vectors together represents the combined risk of all the discovered events and the severity of those events. Thus, FIGS. 4 and 5 provide at-a-glance feedback on a user's fraud probability scores (and sums thereof). In general, FIGS. 4 and 5 illustrate how the severity and fraud probability attributes of specific user events may be used in plotting each event in a two-dimensional plane using polar coordinates.

### C. Identity Theft Risk Report

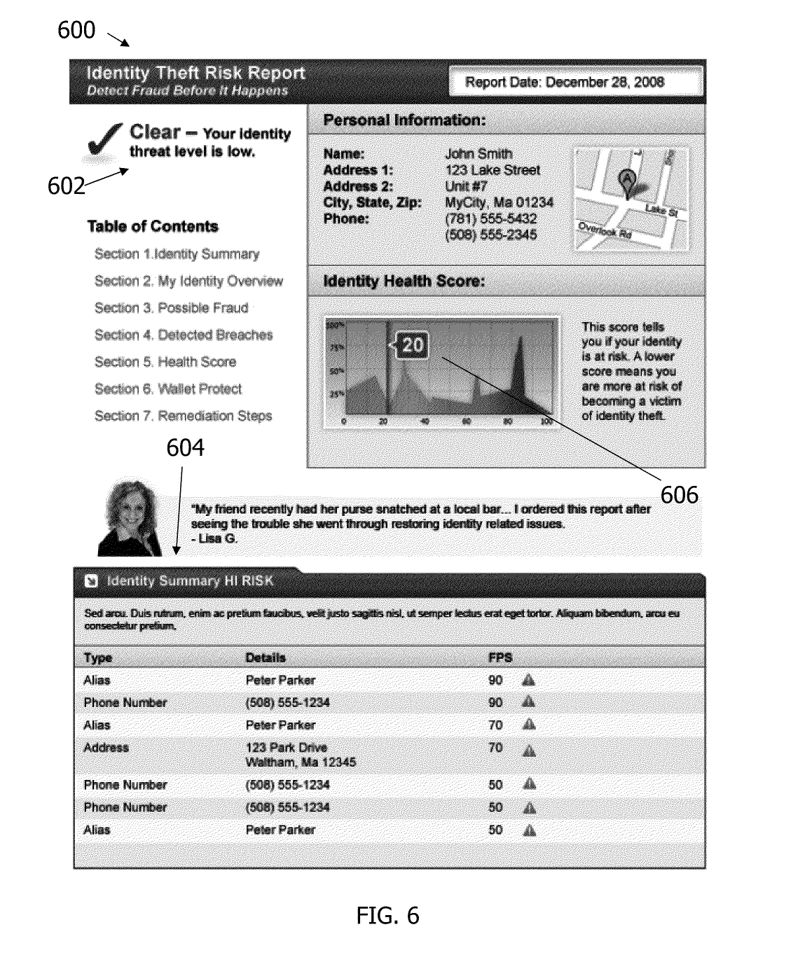

FIG. 6 illustrates, in one embodiment, an identity theft risk report 600 that is provided to an end user requesting information on his or her overall identity health. The risk report 600 may include a high-level indication 602 of the user's identity health, such as “Clear” (for a low identity threat level), “Alert” (for a moderate identity threat level), or “High Alert” (for a high identity threat level). The risk report 600 may further include an identity summary 604 showing a list of relevant identity events. The identity summary 604 may provide a list of the most serious risks (i.e., potentially fraudulent events) to the user's identity health, including names, addresses, and/or phone numbers of possible identity thieves, and their associated fraud probability scores. In addition, the risk report 600 may include the overall identity health score 606 of the end-user.

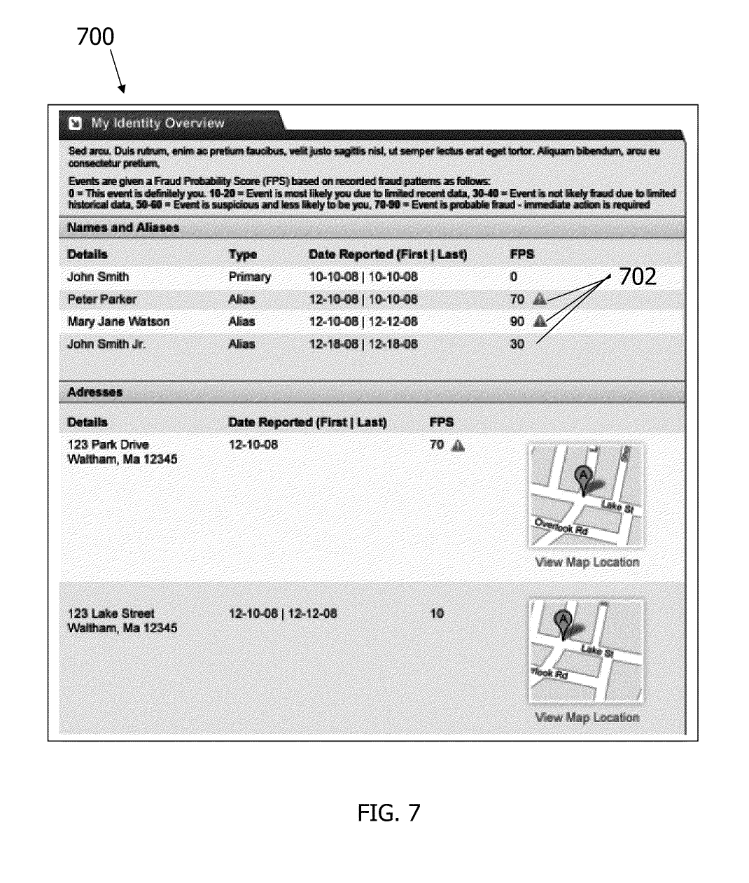

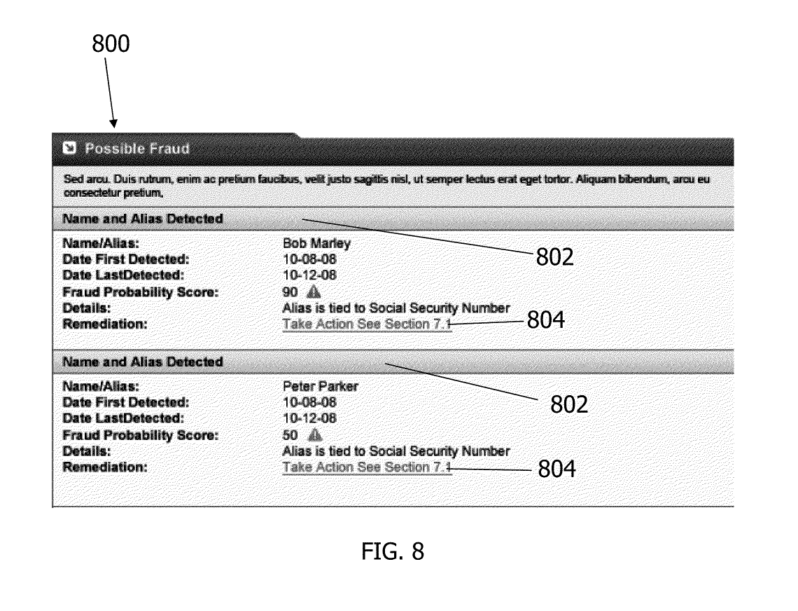

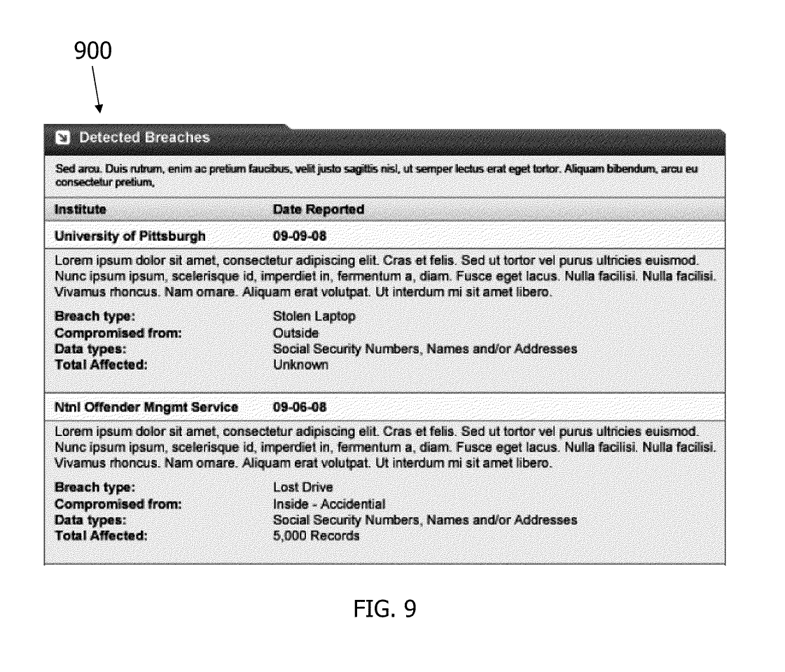

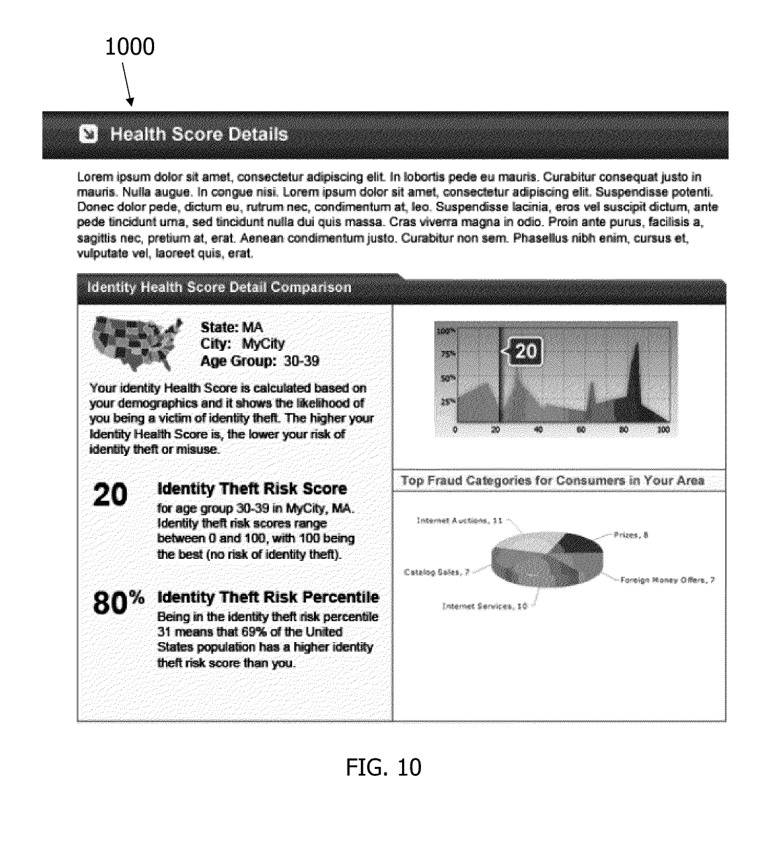

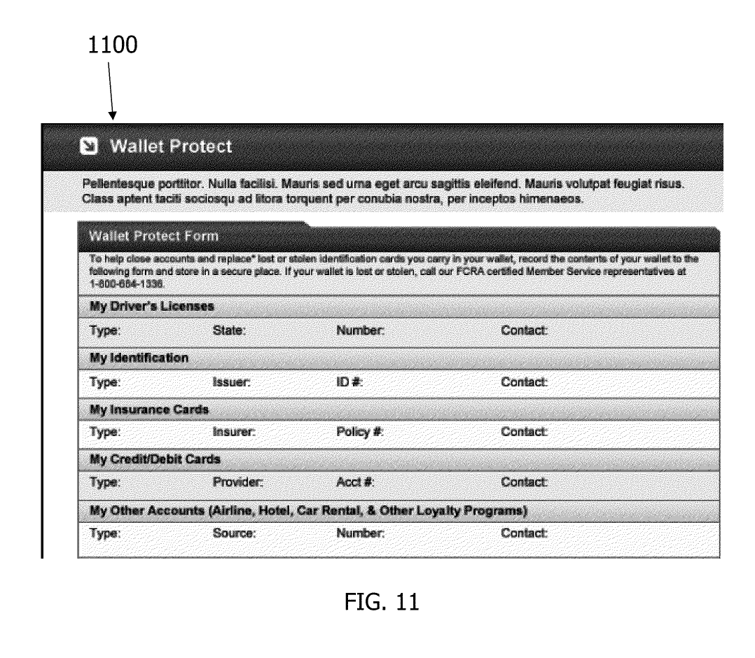

Other information may also be provided by the identity theft risk report 600. FIG. 7 illustrates an identity overview 700 that, in one embodiment, provides more details about the possible identity thieves, including, for each possible risk 702, an alias, an address, a date reported, and a map showing the location of each address. FIG. 8 illustrates a list of cases of possible fraud 800 that shows each possibly fraudulent event 802 with a link 804 that the user may click to take action on each event. FIG. 9 illustrates a list of detected breaches 900 showing known cases of personal data being lost, misplaced, or stolen, such as by the loss or theft of a laptop computer containing sensitive data or attacks on websites containing sensitive data. FIG. 10 illustrates identity health score details 1000 that may give the user an overall indication of his or her identity health, based on, for example, information known about the user and statistical data on the user's demographic. FIG. 11 illustrates a wallet protect summary 1100 that gives a listing of the personal information the user has shared privately so if, for example, the user's wallet or purse is lost or stolen, the user can access credit card numbers, driver's license numbers, etc., to close out those accounts. A list of recommended remediation steps may be included in the event of an identity theft, including a sample report for filing with, e.g., police or insurance agencies.

The identity theft risk report may be provided on a transaction-by-transaction basis, wherein a user pays a certain fixed fee for a one-time snapshot of their identity theft risk. In other embodiments, a user subscribes to the identity theft risk service and risk reports are provided on a regular basis. In these embodiments, alerts are sent to the user if, for example, High Alert events occur.

In one embodiment, the users of the identity theft risk report are private persons. In other embodiments, the users are businesses or corporations. In these embodiments, the corporate user collects identity theft risk data on its employees to, for example, comply with government regulations or to reduce the risk of liability.

### D. Online Truth

In one embodiment, a user is provided with the ability to assess the identity risk of a third party encountered though a computer-based interface (e.g., on the Internet). Many Internet sites, such as auction sites (e.g., eBay.com), dating sites (e.g., Match.com, eHarmony.com), transaction sites (e.g., paypal.com), or social networking sites (e.g., facebook.com, myspace.com, twitter.com) bring a user into contact with anonymous or semi-anonymous third parties. The user may wish to determine the risk involved in dealing with these third parties for either personal or business reasons.

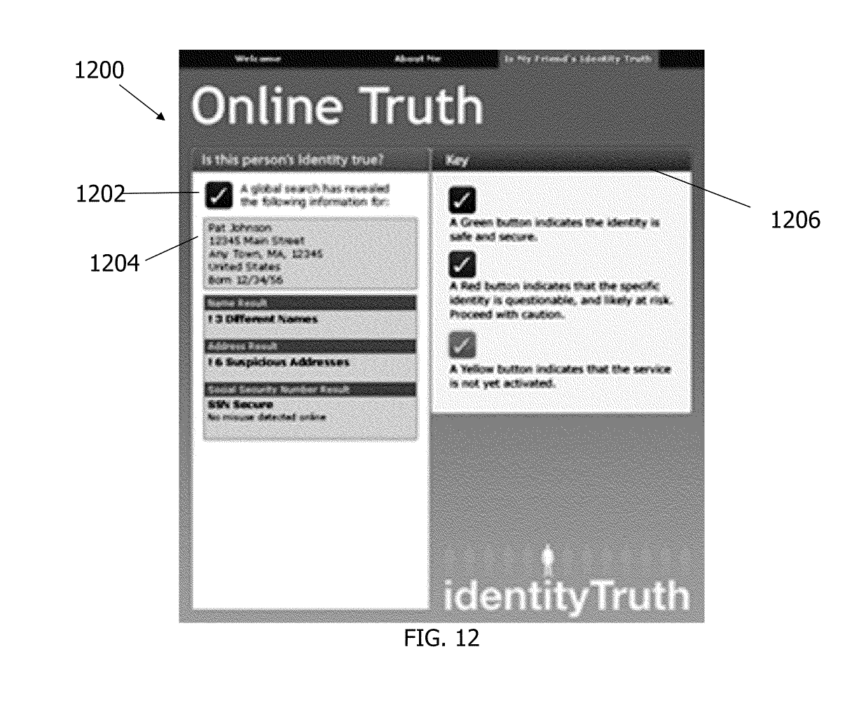

FIG. 12 illustrates, in one embodiment, an online identity health application 1200. A button 1202 displays the status of the identity of a third party 1204. A legend 1206 aids a user in interpreting the status of the button 1202; for example, a green button may indicate that the identity is safe and secure, a red button may indicate that the identity is questionable and likely at risk, and a yellow button may indicate that the service is not yet activated.

In one embodiment, in order to determine the status of a third party, the user provides whatever information is publicly available about the targeted third party, which may include such information as age and city of residence. If event data is known for the third party, the identity health score may be determined by the methods described above. If no event data is known, however, the identity health score of the third party may be determined solely through statistical data using the age of the third party and his or her city of residence.

For example, for a typical individual of the targeted third party's age and residential location, the identity health score may be calculated from the following equations:

Identity Health Score=(HS₁₂)*(1−(Event Score)/120) (11)

and

HS₁₂=100−[D_{b}20+D_{cc}(10*(1−e^{-(STAC/(STAC-1))})+Dₕₑ(20*(HOF))]*0.8 (12)

In these equations, “Event Score” is a factor representing a value for typical identity events that are experienced by an individual of the third party's age and city of residence; D_{b}, D_{cc}, and Dₕₑ are demographic constants that may be chosen based upon the targeted third party's age and city of residence; the variable “STAC” represents the average number of credit cards held by a typical individual in the state in which the third party lives; and the variable “HOF” represents a home ownership factor for a typical individual being of the same age and living in the same location as the targeted third party.

In one embodiment, D_{b} (a demographic base score constant), D_{cc} (a demographic credit card score constant), and Dₕₑ (a demographic home equity score constant) are each chosen to lie between 0.8 and 1.2. In one particular embodiment, the demographic constants are chosen so that D_{b}=D_{cc}=Dₕₑ. Where, however, the targeted third party lives a city in which homes have a relatively high real estate value, Dₕₑ may be increased to represent the greater loss to be incurred by that third party should an identity thief obtain access to the third party's inactive home equity credit line and abuse it.

In one embodiment, knowing only the targeted third party's age and city of residence, the variable “HOF” is determined from the following table:

TABLE 13
HOME OWNERSHIP FACTOR (HOF)
Source: U.S. Census Bureau 2006 statistics

| Age | NE or W | S | MW |
|---|---|---|---|
| <35 | .38 | .43 | .49 |
| 35-44 | .65 | .70 | .75 |
| >44 | .72 | .78 | .80 |

In this table: S=zip codes beginning with 27, 28, 29, 40, 41, 42, 37, 38, 39, 35, 36, 30, 31, 32, 34, 70, 71, 73, 74, 75, 76, 77 78, 79; MW=zip codes beginning with 58, 57, 55, 56, 53, 54, 59, 48, 49, 46, 47, 60, 61, 62, 82, 83, 63, 64, 65, 66, 67, 68, 69; and NE or W=all other zip codes. If, however, the targeted third party's city of residence matches a “principle city”, the HOF determined from Table 13 is, in some embodiments, multiplied by a factor of 0.785 to acknowledge the fact that home ownership in “principle cities” is 55% vs. 70% for the entire country. The U.S. Census Bureau defines which cities are considered to be “principle cities.” Examples include New York City, San Francisco, and Boston.

With knowledge of the targeted third party's city of residence, a value for the variable “STAC” may be obtained from the following table:

TABLE 14
STATE AVERAGE CARDS (STAC)

| State | Avg. cards |
|---|---|
| New Hampshire | 5.3 |
| New Jersey | 5.2 |
| Massachusetts | 5.1 |
| Rhode Island | 5.0 |
| Minnesota | 4.9 |
| Connecticut | 4.8 |
| Maine | 4.7 |
| North Dakota | 4.6 |
| Michigan | 4.5 |
| New York | 4.5 |
| Pennsylvania | 4.5 |
| South Dakota | 4.5 |
| Florida | 4.4 |
| Maryland | 4.4 |
| Montana | 4.4 |
| Nebraska | 4.4 |
| Ohio | 4.4 |
| Vermont | 4.4 |
| Hawaii | 4.3 |
| Virginia | 4.3 |
| Idaho | 4.2 |
| Illinois | 4.2 |
| Wyoming | 4.2 |
| Colorado | 4.1 |
| Delaware | 4.1 |
| Utah | 4.1 |
| Wisconsin | 4.1 |
| United States | 4.0 |
| Iowa | 4.0 |
| Missouri | 4.0 |
| Nevada | 4.0 |
| Washington | 4.0 |
| California | 3.9 |
| Kansas | 3.9 |
| Oregon | 3.9 |
| Indiana | 3.8 |
| Alaska | 3.7 |
| West Virginia | 3.6 |
| Arkansas | 3.5 |
| Arizona | 3.5 |
| Kentucky | 3.5 |
| North Carolina | 3.5 |
| South Carolina | 3.5 |
| Tennessee | 3.5 |
| Georgia | 3.4 |
| New Mexico | 3.4 |
| Alabama | 3.3 |
| Oklahoma | 3.3 |
| Texas | 3.3 |
| Louisiana | 3.2 |
| District of | 3.0 |
| Columbia | |
| Mississippi | 3.0 |

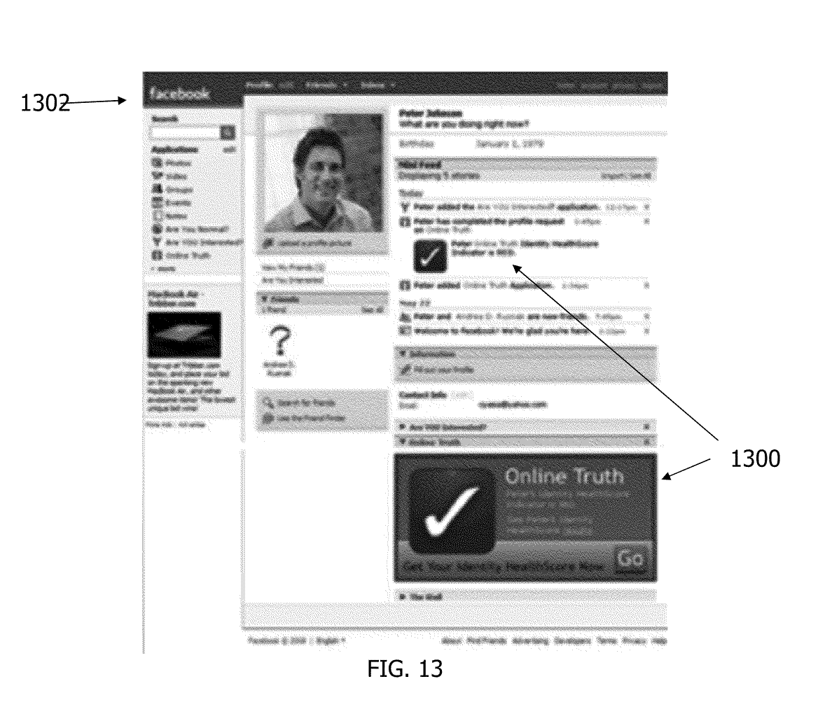

FIG. 13 illustrates an online identity health application 1300 used in a web site 1302. In one embodiment, the user wishes to know the online identity health score of a third party who has opted to broadcast their online identity health score. In this case, the user may simply view the third party's online identity health score by visiting the home page or information page of the third party. For example, the third party's page may display a green status indicator to broadcast a safe online identity health score or a red status indicator to broadcast an unsafe, incomplete, or hidden online identity health score. In one embodiment, a third party who has not chosen to activate the online truth application for their profile displays a yellow status indicator.

In another embodiment, a custom application (created for, e.g., a web site of interest) allows a user to request the online identity health score of a third party using information known to the web site but not to the user. For example, a dating site may collect detailed information about its members, including first and last name, address, phone number, age, gender, date of birth, and even credit card information, but does not display this information to other members. A user requesting the online identity health score of a third party does not need to view this information, however, to know the overall online identity health score of the third party. The custom application may act as a firewall between the public data (online identity health score) and private data (name, age, etc.).

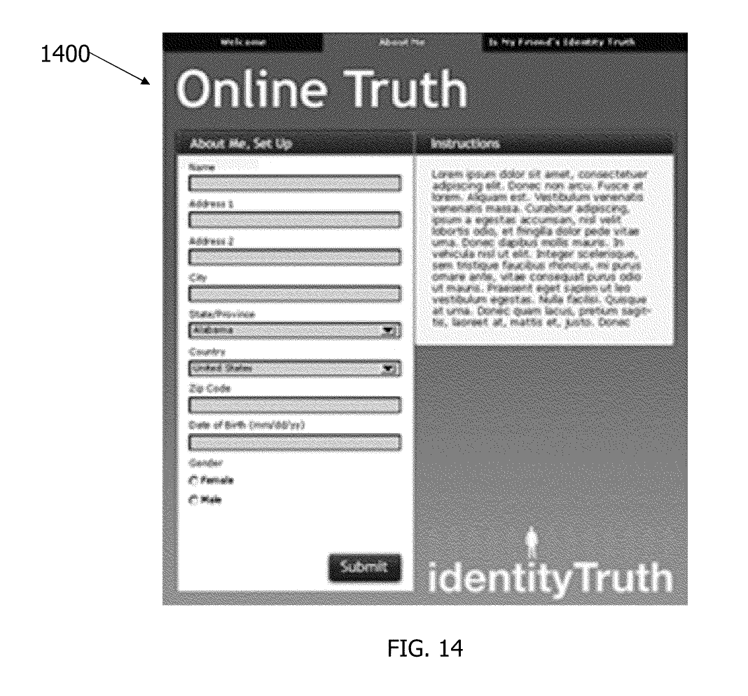

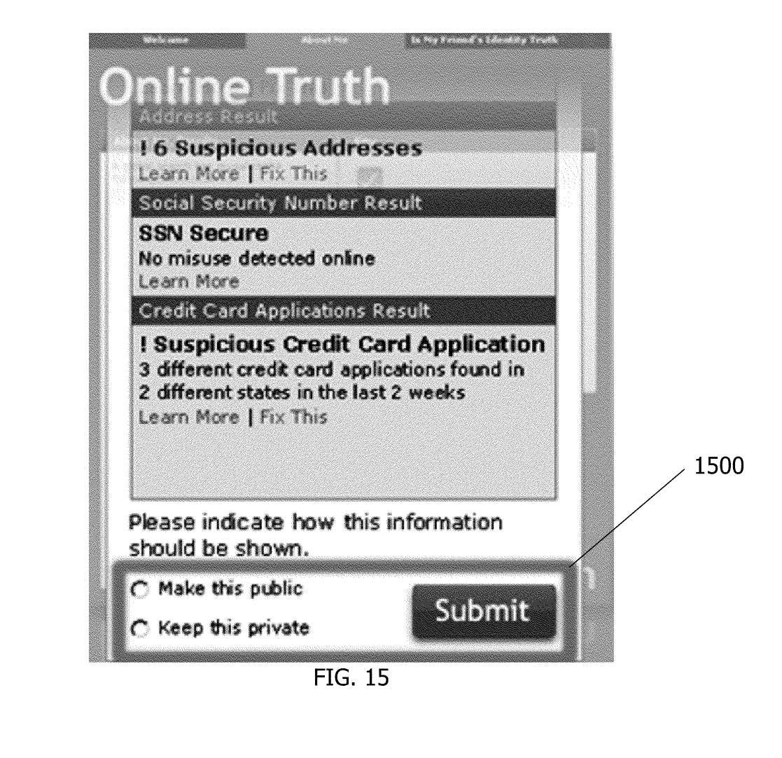

FIG. 14 illustrates an entry form 1400 in which a user may determine his or her own online identity health by entering such information as name, address, phone number, gender, and date of birth into an online truth application. The online truth algorithm may then compute an overall health score for the user, allowing the user to investigate possible problems further. As described above, the identity health score for the user may be found using identity event data, or using only age and demographic data. The user may opt to display the result of the online truth algorithm on an Internet web site of which the user is a member, thereby informing other members of the web site of the user's identity health. For example, if the user has an item for bid on eBay.com, displaying a favorable identity health score may convince other users of eBay.com that the user is trustworthy. Similarly, displaying a favorable identity health score on a social web site like facebook.com or a dating site like Match.com may raise the esteem of the user in the eyes of other members. A user may opt to display favorable results or keep private unfavorable results, as shown in the selection box 1500 in FIG. 15.

In one embodiment, the user publishes his or her online identity health score by posting a link on the desired web site to the result of the online health algorithm. In other embodiments, an online health widget, application, or client is created specifically for each desired web site. The custom widget may display a user's online identity health status in a standard, graphical format, using, for example, different colors to represent different levels of online identity health. The custom widget may reassure a viewer that the listed online identity health is legitimate, and may allow a viewer to click through to more detailed online identity health information.

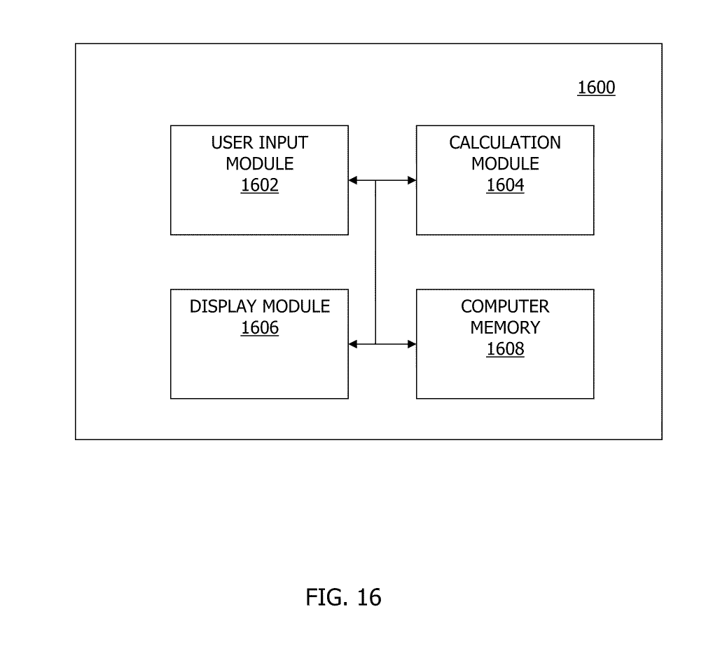

FIG. 16 illustrates, in one embodiment, a system 1600 for providing an online identity health assessment for a user. Once a user identifies a third party on, for example, an Internet web site, the user designates the third party via a user input module 1602. A calculation module 1604 calculates an online identity health score of the third party in accordance with the systems and methods described herein using any available information about the third party. Computer memory 1608 stores the calculated online identity health score of the third party, and a display module 1606 causes the calculated online identity health score of the third party to be displayed to the user.

Like the system 200 described above, the system 1600 may be any computing device (e.g., a server computing device) that is capable of receiving information/data from and delivering information/data to the user. The computer memory 1608 of the system 1600 may, for example, store computer-readable instructions, and the system 1600 may further include a central processing unit for executing such instructions. In one embodiment, the system 1600 communicates with the user over a network, for example over a local-area network (LAN), such as a company Intranet, a metropolitan area network (MAN), or a wide area network (WAN), such as the Internet.

Again, the user may employ any type of computing device (e.g., personal computer, terminal, network computer, wireless device, information appliance, workstation, mini computer, main frame computer, personal digital assistant, set-top box, cellular phone, handheld device, portable music player, web browser, or other computing device) to communicate over the network with the system 1600. The user's computing device may include, for example, a visual display device (e.g., a computer monitor), a data entry device (e.g., a keyboard), persistent and/or volatile storage (e.g., computer memory), a processor, and a mouse. In one embodiment, the user's computing device includes a web browser, such as, for example, the INTERNET EXPLORER program developed by Microsoft Corporation of Redmond, Wash., to connect to the World Wide Web.

Alternatively, in other embodiments, the complete system 1600 executes in a self-contained computing environment with resource-constrained memory capacity and/or resource-constrained processing power, such as, for example, in a cellular phone, a personal digital assistant, or a portable music player.

As before, each of the modules 1602, 1604, and 1606 depicted in the system 1600 may be implemented as any software program and/or hardware device, for example an application-specific integrated circuit (ASIC) or a field-programmable gate array (FPGA), that is capable of providing the functionality described above. Moreover, it will be understood by one having ordinary skill in the art that the illustrated modules and organization are conceptual, rather than explicit, requirements. For example, two or more of the modules may be combined into a single module, such that the functions performed by the two modules are in fact performed by the single module. Similarly, any single one of the modules may be implemented as multiple modules, such that the functions performed by any single one of the modules are in fact performed by the multiple modules.

Moreover, it will be understood by those skilled in the art that FIG. 16 is a simplified illustration of the system 1600 and that it is depicted as such to facilitate the explanation of the present invention. The system 1600 may be modified in a variety of manners without departing from the spirit and scope of the invention. For example, rather than being implemented on a single computing device 1600, the modules 1602, 1604 and 1606 may be implemented on two or more computing devices that communicate with one another directly or over a network. As such, the depiction of the system 1600 in FIG. 16 is non-limiting.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A computing system that evaluates a fraud probability score for an identity event, the system comprising:
a search module that queries a data store to identify an identity event relevant to a user, the data store storing identity event data;
a behavioral module that models a plurality of categories of suspected fraud; and
a fraud probability module that computes, and stores in computer memory, a fraud probability score indicative of a probability that the identity event is fraudulent based at least in part on applying the identity event to a selected one of the categories modeled by the behavioral module.

2. The system of claim 1, wherein each modeled category of suspected fraud is based at least in part on at least one of demographic data or fraud pattern data.

3. The system of claim 1, further comprising a history module that compares the identity event to historical identity events linked to the identity event, and wherein the fraud probability score further depends on a result of the comparison.

4. The system of claim 1, further comprising an identity health score module that computes an identity health score for the user based at least in part on the computed fraud probability score.

5. The system of claim 4, further comprising a fraud severity module for assigning a severity to the identity event, and wherein the identity health score further depends on the assigned severity.

6. The system of claim 1, wherein the identity event is a non-financial event.

7. The system of claim 1, wherein the identity event data comprises credit header data.

8. The system of claim 1, wherein the identity event comprises at least one of a name identity event, an address identity event, a phone identity event, or a social security number identity event.

9. The system of claim 1, wherein the fraud probability module comprises a name fraud probability module that compares a name of the user to a name associated with the identified identity event.

10. The system of claim 9, wherein the name fraud probability module computes the fraud probability score using at least one of a longest-common-substring algorithm or a string-edit-distance algorithm.

11. The system of claim 9, wherein the name fraud probability module generates groups of similar names, a first group of which comprises the name of the user, and wherein the name fraud probability module compares the name associated with the identified identity event to each group of names.

12. The system of claim 1, wherein the fraud probability module comprises a social security number fraud probability module that compares a social security number of the user to a social security number associated with the identified identity event.

13. The system of claim 1, wherein the fraud probability module comprises an address fraud probability module that compares an address of the user to an address associated with the identified identity event.

14. The system of claim 1, wherein the fraud probability module comprises a phone number fraud probability module that compares a phone number of the user to a phone number associated with the identified identity event.

15. The system of claim 1, wherein the fraud probability module aggregates a plurality of computed fraud probability scores.

16. The system of claim 1, wherein the fraud probability module computes the fraud probability score dynamically as the identified identity event occurs.

17. An article of manufacture storing computer-readable instructions thereon for evaluating a fraud probability score for an identity event relevant to a user, the article of manufacture comprising:
instructions that query a data store storing identity event data to identify an identity event relevant to an account of the user, the identity event having information that matches at least part of one field of information in the account of the user;
instructions that compute, and thereafter store in computer memory, a fraud probability score indicative of a probability that the identity event is fraudulent by applying the identity event to a model selected from one of a plurality of categories of suspected fraud models modeled by a behavioral module; and
instructions that cause the presentation of the fraud probability score on a screen of an electronic device.

18. The article of manufacture of claim 17, wherein the fraud probability score comprises at least one of a name fraud probability score, a social security number fraud probability score, an address fraud probability score, or a phone fraud probability score.

19. The article of manufacture of claim 17, wherein the instructions that compute comprise instructions that use at least one of a longest-common-substring algorithm or a string-edit-distance algorithm.

20. The article of manufacture of claim 17, wherein the instructions that compute comprise instructions that group similar names, a first group of which comprises the name of the user, and that compare a name associated with the identity event to each group of names.

21. A method for evaluating a fraud probability score for an identity event relevant to a user, the method comprising:
querying a data store storing identity event data to identify an identity event relevant to an account of the user, the identity event having information that matches at least part of one field of information in the account of the user;
computing, and thereafter storing in computer memory, a fraud probability score indicative of a probability that the identity event is fraudulent by applying the identity event to a model selected from one of a plurality of categories of suspected fraud models modeled by a behavioral module; and
causing the presentation of the fraud probability score on a screen of an electronic device.

22. The method of claim 21, wherein the step of computing the fraud probability score further comprises using historical identity data to compare the identity event to historical identity events linked to the identity event, and wherein the fraud probability score further depends on a result of the comparison.

23. The method of claim 21, further comprising assigning a severity to the identity event, and wherein the fraud probability score further depends on the assigned severity.

24. The method of claim 21, further comprising computing an identity health score based at least in part on the computed fraud probability score.

25. A computing system that provides an identity theft risk report to a user, the system comprising:
computer memory that stores identity event data, identity information provided by a user, and statistical financial and demographic information;
a fraud probability module that computes, and thereafter stores in the computer memory, at least one fraud probability score for the user by comparing the identity event data with the identity information provided by the user;
an identity health module that computes, and thereafter stores in the computer memory, an identity health score for the user by evaluating the user against the statistical financial and demographic information; and
a reporting module that provides an identity theft risk report to the user, the report comprising at least the fraud probability and identity health scores of the user.

26. The system of claim 25, wherein the reporting module communicates a snapshot report to a transaction-based user.

27. The system of claim 25, wherein the reporting module communicates a periodic report to a subscription-based user.

28. The system of claim 25, wherein the user is a private person.

29. The system of claim 25, wherein the reporting module communicates the identity theft risk report to at least one of a business or a corporation.

30. An article of manufacture storing computer-readable instructions thereon for providing an identity theft risk report to a user, the article of manufacture comprising:
instructions that compute, and thereafter store in computer memory, at least one fraud probability score for the user by comparing identity event data stored in the computer memory with identity information provided by the user;
instructions that compute, and thereafter store in the computer memory, an identity health score for the user by evaluating the user against statistical financial and demographic information stored in the computer memory; and
instructions that provide an identity theft risk report to the user, the report comprising at least the fraud probability and identity health scores of the user.

31. A computing system that provides an online identity health assessment to a user, the system comprising:
a user input module that accepts user input designating an individual other than the user for an online identity health assessment, the other individual having been presented to the user on an internet web site;
a calculation module that calculates an online identity health score for the other individual using information identifying, at least in part, the other individual;
computer memory that stores the calculated online identity health score for the other individual; and
a display module that causes the calculated online identity health score of the other individual to be displayed to the user.

32. The system of claim 31, wherein the internet web site is selected from the group consisting of a social networking web site, a dating web site, a transaction web site, and an auction web site.

33. The system of claim 31, wherein the information identifying the other individual is unknown to the user.

34. An article of manufacture storing computer-readable instructions thereon for providing an online identity health assessment to a user, the article of manufacture comprising:
instructions that accept user input designating an individual other than the user for an online identity health assessment, the other individual having been presented to the user on an internet web site;
instructions that calculate, and that thereafter store in computer memory, an online identity health score for the other individual using information identifying, at least in part, the other individual; and
instructions that cause the calculated online identity health score for the other individual to be displayed to the user.
